(19) United States
(12) Patent Application Publication
(10) Pub. No.: US 2019/0301808 A1
(43) Pub. Date: Oct. 3, 2019

(54) Sensible and Latent Heat Exchangers with Particular Application to Vapor-Compression Desalination

(71) Applicant: The Texas A&M University System, College Station, TX (US)

(72) Inventor: Mark Thomas Holtzapple, College Station, TX (US)

(73) Assignee: The Texas A&M University System, College Station, TX (US)

(21) Appl. No.: 16/466,919

(22) PCT Filed: Dec. 13, 2017
(86) PCT No.: PCT/US2017/066215

§ 371 Date: Jun. 5, 2019

Related U.S. Application Data
(60) Provisional application No. 62/433,508, filed on Dec. 13, 2016.

(51) Int. Cl. F28D 7/16; F28F 13/08; B01D 1/08; B01D 5/00; C02F 1/04

(52) U.S. Cl. CPC F28D 7/16; F28F 13/08; B01D 1/08; F28D 2021/0064; B01D 5/006; C02F 1/04; B01D 5/009; B01D 5/0012

(57) ABSTRACT

A heat exchanger includes a shell, and a tube assembly disposed in the shell, the tube assembly including at least one tube, wherein the tube has a pair of end sections having a first diameter and a central section extending between the end sections having a second diameter that is greater than the first diameter.

### CROSS-REFERENCE TO RELATED APPLICATIONS

The present application is a 35 U.S.C. § 371 national stage application of PCT/US2017/066215 filed Dec. 13, 2017, and entitled “Sensible and Latent Heat Exchangers with Particular Application to Vapor-Compression Desalination,” which claims benefit of U.S. provisional patent application No. 62/433,508 filed Dec. 13, 2016, entitled “Sensible and Latent Heat Exchangers with Particular Application to Vapor-Compression Desalination,” each of which is incorporated herein in its entirety for all purposes.

### STATEMENT REGARDING FEDERALLY SPONSORED RESEARCH OR DEVELOPMENT

Not applicable.

### BACKGROUND

This disclosure relates to heat exchanger technology that is broadly applicable, but may have particular use in vapor-compression desalination of seawater and brackish water. Additionally, this disclosure relates to systems and methods for increasing a pressure range in which commercially available lobe compressors may operate. It is estimated that around 30% of the world's irrigated areas suffer from salinity problems and remediation may be very costly. In 2002, there were about 12,500 desalination plants around the world in 120 countries. These desalination plants produced about 14 million cubic meters/day of freshwater, which may be less than 1% of total world consumption. The high cost of desalination has kept desalination from being used more often. Consequently, there is a need for improved desalination processes.

### SUMMARY

An embodiment of a heat exchanger comprises a shell; and a tube assembly disposed in the shell, the tube assembly comprising at least one tube; wherein the tube has a pair of end sections having a first diameter and a central section extending between the end sections having a second diameter that is greater than the first diameter. In some embodiments, each end section of the tube has a circular cross-section and the central section of the tube has a rectangular cross-section configured to provide a countercurrent flow through the heat exchanger. In some embodiments, each end section of the tube has a circular cross-section and the central section of the tube has a star shaped cross-section. In certain embodiments, the central section of the tube comprises a plurality of concave channels formed on an outer surface thereof in certain embodiments, the tube assembly comprises a plurality of the tubes, and wherein each tube of the tube assembly contacts another tube of the tube assembly. In some embodiments, a plurality of square channels are formed between the central sections of the plurality of tubes. In some embodiments, the heat exchanger further comprises a pair of tube sheet connectors extending from the shell; and a pair of tube sheets coupled to the tube of the tube assembly and slidably insertable into the tube sheet connectors. In certain embodiments, the heat exchanger further comprises a pump disposed in the shell and configured to pump a fluid through the tube of the tube assembly. In certain embodiments, the pump comprises a pulse plate and is configured to produce short oscillations and superimposed large oscillations in the pulse plate. In some embodiments, the heat exchanger further comprises an outer shell configured to receive the shell and the tube assembly.

An embodiment of a desalination system comprises a heat source configured to produce steam; and a first shell-and-tube heat exchanger comprising an evaporator and a condenser; wherein the evaporator is configured to receive a feed stream of seawater mixed with the steam produced by the heat source and output a separated vapor stream and a separated liquid stream from the received feed stream; wherein the condenser is configured to condense the vapor stream produced from the evaporator into a distilled water stream. In some embodiments, the desalination system further comprises a compressor configured to compress the vapor stream outputted from the evaporator. In some embodiments, the compressor comprises an inner housing; a plurality of lobed rotors disposed in the inner housing; an outer housing that receives the inner housing; a fluid inlet configured to provide a fluid flow to the inner housing; and a fluid outlet configured to discharge fluid from the inner housing. In certain embodiments, the desalination system further comprises a second shell-and-tube heat exchanger comprising a shell; and a tube assembly disposed in the shell, the tube assembly comprising at least one tube; wherein the tube has a pair of end sections having a first diameter and a central section extending between the end sections having a second diameter that is greater than the first diameter. In certain embodiments, the central section of the tube comprises a plurality of concave channels formed on an outer surface thereof In some embodiments, the evaporator comprises the tube side of the first shell-and-tube heat exchanger and the condenser comprises the shell side of the first shell-and-tube heat exchanger.

An embodiment of a method for vapor-compression desalination comprises (a) flowing a feed stream into an evaporator of a first shell-and-tube heat exchanger; (b) separating the feed stream in the evaporator of the first shell-and-tube heat exchanger into separated vapor stream and a separated liquid stream; and (c) condensing the separated vapor stream in a condenser of the first shell-and-tube heat exchanger in some embodiments, the evaporator comprises the tube side of the first shell-and-tube heat exchanger and the condenser comprises the shell side of the first shell-and-tube heat exchanger. In some embodiments, the method further comprises (d) flowing the feed stream through a second shell-and-tube heat exchanger; and (e) flowing the condensed fluid outputted from the condenser of the first shell-and-tube heat exchanger countercurrently through the second shell-and-tube heat exchanger. In certain embodiments, the method further comprises (i) flowing the condensed fluid through a turbine to produce shaft work.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis tier modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of the disclosed embodiments, reference will now be made to the accompanying drawings in which:

FIG. 1 is a schematic view of an embodiment of a desalination system in accordance with principles disclosed herein;

FIG. 2 is a schematic view of an embodiment of a compressor of the desalination system of FIG. 1 in accordance with principles disclosed herein;

FIG. 3 is a schematic view of an embodiment of a sensible heat exchanger of the desalination system of FIG. 1 in accordance with principles disclosed herein;

FIG. 4 is a perspective view of a central section plurality of tubes of the sensible heat exchanger of FIG. 3;

FIGS. 5A-5C are schematic representations of an embodiment of a swaging process for forming the sensible heat exchanger of FIG. 3 in accordance with principles disclosed herein;

FIGS. 6A-6C are schematic representations of another embodiment of a swaging process for forming the sensible heat exchanger of FIG. 3 in accordance with principles disclosed herein;

FIG. 7 is a schematic view of another embodiment of a sensible heat exchanger of the desalination system of FIG. 1 in accordance with principles disclosed herein;

FIG. 8 is a perspective view of a plurality of tubes of the sensible heat exchanger of FIG. 7;

FIG. 9 is a front view of an end section plurality of tubes of the sensible heat exchanger of FIG. 7;

FIG. 10 is a front view of an embodiment of a latent heat exchanger of the desalination system of FIG. 1 in accordance with principles disclosed herein;

FIG. 11 is a zoomed-in view of an embodiment of a tube sheet connector of the latent heat exchanger of FIG. 10 in accordance with principles disclosed herein;

FIG. 12 is a side view of the latent heat exchanger of FIG. 10;

FIG. 13 is a top view of the latent heat exchanger of FIG. 10;

FIG. 14 is a side view of an embodiment of a tube of the latent heat exchanger of FIG. 10 in accordance with principles disclosed herein;

FIG. 15 is a front view of a plurality of the tubes of FIG. 14;

FIG. 16 is a side view of another embodiment of a latent heat exchanger of the desalination system of FIG. 1 in accordance with principles disclosed herein;

FIG. 17 is a front view of the latent heat exchanger of FIG. 16;

FIG. 18 is a side view of another embodiment of a latent heat exchanger of the desalination system of FIG. 1 in accordance with principles disclosed herein;

FIG. 19 is a front view of the latent heat exchanger of FIG. 18;

FIG. 20 is a side view of an embodiment of a pump of the latent heat exchanger of FIG. 18 in accordance with principles disclosed herein;

FIG. 21 is a side view of another embodiment of a latent heat exchanger of the desalination system of FIG. 1 in accordance with principles disclosed herein;

FIG. 22 is a front view of the latent heat exchanger of FIG. 21;

FIG. 23 is a side view of an embodiment of a pump of the latent heat exchanger of FIG. 21 in accordance with principles disclosed herein;

FIG. 24 is a side view of another embodiment of a latent heat exchanger of the desalination system of FIG. 1 in accordance with principles disclosed herein;

FIG. 25 is a front view of the latent heat exchanger of FIG. 24;

FIG. 26 is a side view of another embodiment of a latent heat exchanger of the desalination system of FIG. 1 in accordance with principles disclosed herein;

FIG. 27 is a graph illustrating work dissipated from friction relative to heat transfer coefficient;

FIG. 28 is a graph illustrating one-side heat transfer coefficient for water as a function of hydraulic diameter and fluid velocity; and

FIGS. 29-31 are schematic representations of an analysis of a star-shaped tube.

### DETAILED DESCRIPTION

The following discussion is directed to various exemplary embodiments. However, one skilled in the art will understand that the examples disclosed herein have broad application, and that the discussion of any embodiment is meant only to he exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name hut not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. Any reference to up or down in the description and the claims is made for purposes of clarity, with “up”, “upper”, “upwardly”, “uphole”, or “upstream” meaning toward the surface of the borehole and with “down”, “lower”, “downwardly”, “downhole”, or “downstream” meaning toward the terminal end of the borehole, regardless of the borehole orientation. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

In embodiments disclosed herein, flow within the sensible heat exchangers may be completely countercurrent rather than the crossflow of traditional shell-and-tube heat exchangers. Crossflow may not be as efficient as countercurrent. Crossflow heat exchangers may have a large pressure drop because of induced turbulence as the fluid flows perpendicular to the tube. In embodiments disclosed herein, the flow within the heat exchanger may be parallel to the tube, so there may be less of a pressure drop. The tube geometry may not be uniform along the length. At each end, the diameter may be smaller, which may allow the shell-side fluid to distribute readily in the radial direction. Additionally, to aid in distributing the flow in the radial direction, the shell diameter at each end may be enlarged.

The tube geometry may be determined by hydroforming, which may allow flexibility to optimize the tube geometry for a given application. Hydroforming may reduce wall thickness below that which is standardly available, which may save material costs and reduce heat transfer resistance. The heat exchanger may not include baffles, which may reduce assembly complexity and may reduce cost. The tube diameter may be small, which may increase heat transfer per unit volume.

Additionally, latent heat exchangers may evaporate water and concentrate solutes, such as salt or sugar. Latent heat exchangers may be used to desalinate water, crystalize salts, concentrate sugars, and many other applications. Because water may have a high latent heat of vaporization, the heat duty may be very large. To ensure that the heat exchanger has a reasonable size and economical cost, it may he desired to have high overall heat transfer coefficients. One side of the heat exchanger may have condensing steam, and the other may have boiling water. Provided dropwise condensation may be achieved on a condensing side, the overall heat transfer coefficient may be large and may help reduce the size of the latent heat exchanger. Further, if the latent heat exchanger is employed in a vapor-compression system, the latent heat exchanger may operate with a small temperature differential, which may reduce the pressure of the condensing steam and hence may reduce the input power needed for the compressor.

Lobe compressors (i.e., Roots blowers) may be used to compress the vapor; however, commercially available units may be unable to operate at high pressures, which may be required to achieve high heat transfer rates in the latent heat exchanger. This problem may be overcome by placing a commercially available lobe compressor in a pressure vessel filled with pressurized steam that nearly matches the pressure in the heat exchanger.

The foregoing has outlined rather broadly the features and technical advantages of the present disclosure in order that the detailed description that follows may be better understood. Additional features and advantages of the disclosure will be described hereinafter that form the subject of the claims. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

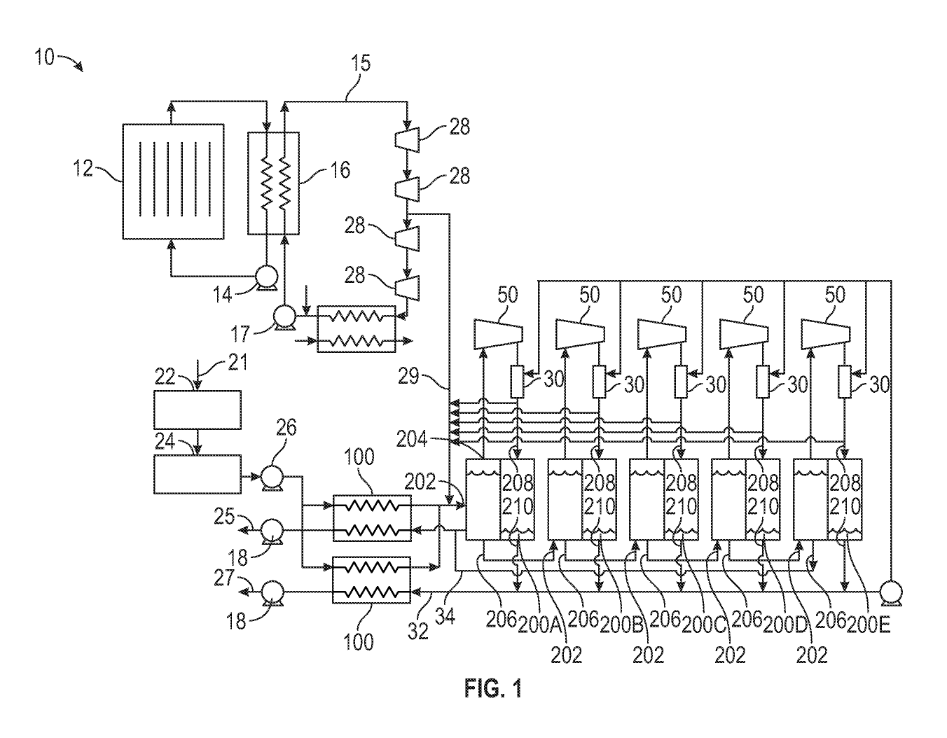

Referring to FIG. 1, an embodiment of a desalination or vapor-compression evaporation system 10 is shown. In the embodiment of FIG. 1, evaporation system 10 includes a Rankine cycle heat engine in which a heat source 12 (e.g., combustion, waste heat, solar, nuclear, or other heat types of heat sources) heats a working fluid circulated by a pump 14 through a boiler 16 to produces high-pressure steam 15 circulated by a pump 17. The steam 15 produced by heat source 12 powers a series of expanders 28 to produce shaft work that may be used to produce electricity or directly drive compressors 50 of the vapor-compression evaporation system. In other embodiments, the shaft work may be produced by other heat engines (e.g., Otto, Diesel, Brayton, Stirling, Ericsson, etc.). In such engines, waste heat can be captured to make steam that assists in the desalination system. In still other embodiments, the heat engine may be removed and replaced with an electric motor, or other suitable power source that may drive the compressors 50 of evaporation system 10.

In this embodiment, vapor-compression evaporation system 10 is configured to remove volatile components from a solution containing non-volatile components. Particularly, evaporation system 10 is configured to remove salt dissolved in seawater; however, in other embodiments, evaporation system 10 may remove other components, such as sugar from water or salt from dilute brine or a saturated salt solution. Thus, in this embodiment, evaporation system 10 comprises a desalination system. In this embodiment, raw seawater 21 is pretreated using a carbonate remover 22 and a sulfate remover 24 to remove carbonate and sulfate therefrom and thereby mitigate or prevent the formation of scale in components of evaporation system 10 exposed to seawater 21. In some embodiments, the pH of seawater 21 is adjusted to about 4.3 so that carbonate is converted to carbon dioxide, which may be removed readily by stripping or vacuum suction in carbonate remover 22. Then, sulfates may be removed via ion exchange in sulfate remover 24. In this embodiment, spent ion exchange resin from sulfate remover is regenerated using a brine 25 discharged from evaporation system 10, eliminating the consumption of chemicals. Such a system is described in the following journal article: L Zhu, C B Granda, M T Holtzapple, Prevention of calcium sulfate formation in seawater desalination by ion exchange, Desalination and Water Treatment, 36 (1-3): 57-64 (2011).

In this embodiment, evaporation system 10 comprises a pair of sensible heat exchangers 100 that receive the seawater 21 pretreated by carbonate remover 22 and sulfate remover 24 via a pump 26 of system 10. Sensible heat exchangers 100 heat the seawater 21 to approximately 177.87° C. After flowing through sensible heat exchangers 100, steam 15 is added to seawater 21 prior to flowing seawater 21 into a plurality of latent heat exchangers 200. In this embodiment, each of heat exchangers 100 and 200 comprise shell-and-tube heat exchangers; however, in other embodiments, heat exchangers 100 and 200 may comprise other types of heat exchangers known in the art. The addition of steam 15 to seawater 21 heats the seawater 21 to approximately 180° C. so the seawater 21 may be fed to the latent heat exchangers 200. In this embodiment, a portion of steam 15 may be provided to seawater 21 via a plurality of expanders 28 positioned downstream of boiler 16 and/or a plurality of desuperheaters 30 positioned downstream of compressors 50. Particularly, a steam injection line 29 allows at least a portion of the expanded steam 15 to be injected into the stream of pretreated seawater 21. Because steam may be bled from expanders 28 during the operation of evaporation system 10, make-up water may be added to make up for losses of steam 15. In other embodiments where evaporation system 10 does not include a heat engine that employs steam, a separate steam generator may be employed in evaporation system 10. Alternatively, steam can be produced from the waste heat produced by other heat engines (e.g., Otto, Diesel, Brayton, Stirling, Ericsson, etc.).

In this embodiment, evaporation system 10 comprises five latent heat exchangers 200A-200E, where a first latent heat exchanger 200A. Each latent heat exchanger 200A-200E includes an evaporator side or evaporator inlet 202, a first or vapor evaporator outlet 204, and a second or liquid evaporator outlet 206. The evaporator inlet 202 of the first latent heat exchanger 200A receives the stream of seawater 21 and steam 15 while the evaporator inlet 202 of each subsequent latent heat exchanger 200B-200E receives a fluid flow from the evaporator liquid outlet 206 of the preceding latent heat exchanger 200B-200D. For instance, the evaporator inlet 202 of second latent heat exchanger 200B receives a fluid flow from the evaporator liquid outlet 206 of first latent heat exchanger 200A.

Further, each latent heat exchanger 200A-200E includes a condenser side or condenser inlet 208 and a condenser outlet 210. An overhead vapor stream flowing from the evaporator vapor outlet 204 of each latent heat exchanger 200A-200E flows through a compressor 50 and desuperheater 30 before flowing into the condenser side of the same heat exchanger 200A-200E via condenser inlet 208. Particularly, vapor (e.g., steam) that evaporates in the first latent heat exchanger 200A, exiting the evaporator side of heat exchanger 200A via evaporator vapor outlet 204, is compressed by a compressor 50, producing superheated steam. The superheated steam discharged from compressor 50 may be removed by spraying atomized saturated liquid water into a desuperheater 30 located downstream of compressor 50. In some embodiments, each desuperheater 30 comprises a simple pipe with enough residence time to vaporize the atomized saturated liquid water. The water vaporized in desuperheater 30 may contribute to the stream of steam 15 injected into seawater 21 (via injection line 29), which, in this embodiment, heats the seawater 21 to approximately 180° C. prior to flowing into the evaporator inlet 202 of the first latent heat exchanger 200A. In this embodiment, the saturated steam exiting desuperheater 30 is fed to the condenser side or condenser of the first latent heat exchanger 200A via condenser inlet 208 to produce distilled water that exits first latent heat exchanger 200A via condenser outlet 210. In this embodiment, the heat of the condensation occurring in the condenser of each latent heat exchanger 200A-200E passes through a wall of the heat exchanger 200A-. 200E and becomes the heat of evaporation of the evaporator of the latent heat exchanger 200A-200E that evaporates steam from the salt or seawater provided thereto. The heat from condensation may be recycled repeatedly using a small amount of shaft power provided to compressors 50. Additionally, in this embodiment, each compressor 50 pressurizes the heated steam flowing from evaporator vapor outlet 204 to a predetermined or desired pressure so that heat may transfer through the wall of each latent heat exchanger 200A-200E that separators the evaporator and condenser of each heat exchanger 200A-200E. In this embodiment, the evaporator of each latent heat exchanger 200A-200E comprises the tube side of heat exchangers 200A-200E while the condenser comprises the shell side of heat exchangers 200A-200E; however, in other embodiments, the evaporator of each latent heat exchanger 200A-200E comprises the shell side of heat exchangers 200A-200E while the condenser comprises the tube side of heat exchangers 200A-200E.

In this embodiment, the evaporator liquid outlet 206 of each latent heat exchanger 200A-200E discharges a stream of salt water or brine that is supplied to the evaporator inlet 202 of the subsequent latent heat exchanger 200B-200E. The brine discharged from the evaporator liquid outlet 204 of the first latent heat exchanger 200A has a higher salt content or concentration than seawater 21. Indeed, the salt content of the brine discharged may be continually increased as the brine is discharged from the evaporator liquid outlet 204 of subsequent latent heat exchangers 200B-200E. For instance, the evaporator liquid outlet 204 of fifth latent heat exchanger 200E may have a higher salt content than the brine discharged from the evaporator liquid outlet 204 of first latent heat exchanger 200A. Although in this embodiment evaporation system 10 includes five latent heat exchangers 200A-200E, in other embodiments, the number of latent heat exchangers included in evaporation system 10 may differ. In some applications, increasing the number of latent heat exchangers 200 may improve the energy efficiency of evaporation system 10 because the process may more closely approximate reversible evaporation.

In this embodiment, the condenser outlet 210 of each latent heat exchanger 200A-200E discharged distilled water 27 into a water outlet line 32. Additionally, in this embodiment, concentrated brine 25 discharged from the evaporator liquid outlet 206 of fifth latent heat exchanger 200E is discharged into a brine outlet line 34. The concentrated brine 25 and distilled water 27 discharged from latent heat exchangers 200A-200E may be hot and have a high pressure. Additionally, in this embodiment, sensible heat exchangers 100 exchange heat with the incoming seawater 21. In this embodiment, after being discharged from sensible heat exchangers 200A-200E, the brine 25 and distilled water 27 pass through turbines 18 which recover pressure energy in the form of shaft work. In some embodiments, the brine 25 and distilled water 27 exit evaporation system 10 at a temperature of approximately 2.13° C. warmer than the incoming seawater 21 received by evaporation system 10, although in other embodiments the temperature difference between brine 25, distilled water 27, and seawater 21 may vary. This slight temperature rise may come from the net energy input in the form of shaft power and a small amount of direct steam injection via injection line 29.

As will he described further herein, evaporation system 10 includes many features having advantages over conventional evaporator systems, including: latent heat exchangers 200A-200E operate at relatively high temperatures and pressures, which may improve heat transfer coefficients; dropwise condensation may be employed in latent heat exchangers 200A-200E, which may greatly reduce the required temperature difference (e.g., 0.2° C.) and may improve energy efficiency; high-efficiency positive-displacement compressors (e.g., compressors 50 of evaporation system 10) may be employed; and novel sensible and latent heat exchangers may be employed (e.g., sensible heat exchangers 100 and latent heat exchangers 200A-200E), which may be effective, but inexpensive. In the embodiment of FIG. 1, the pressure ratio in each stan of compressors 50 (e,g., the compressor 50 of first latent heat exchanger 200A being the first stage and the compressor 50 of fifth latent heat exchanger 200E being the fifth stage) is as follows: stage 1—1.0267; stage 2—1.0315; stage 3—1,0389; stage 4—1.0520; stage 5—1.0808; however, in other embodiments, the pressure ratio of each stage of compressors 50 may differ.

Compressors 50 of evaporation system 10 may comprise many compressor types may be used including dynamic compressors (e.g., axial, centrifugal) and positive displacement (e.g., gerotor, rotary lobe). In this embodiment, compressors 50 comprise positive displacement compressors. Positive displacement compressors may he attractive options because they may have a wide turndown ratio, meaning they may maintain efficiency when operated over a wide range of speeds. Also, positive displacement compressors may maintain efficiency even when operated far from their design conditions. The rotary lobe compressor actually does not compress the vapor and may be best characterized as a “blower.” Given that in this embodiment the pressure ratio of each stage of compressors 50 is relatively low (e.g., 1.1 or lower), compressors 50 comprise rotary lobe compressors having an efficiency of approximately 90 % or greater at pressure ratios of 1.1 or lower. However, in embodiments having compressor stages with relatively high pressure ratios (e.g., 1.5 or greater), compressors 50 may comprise georotor compressors.

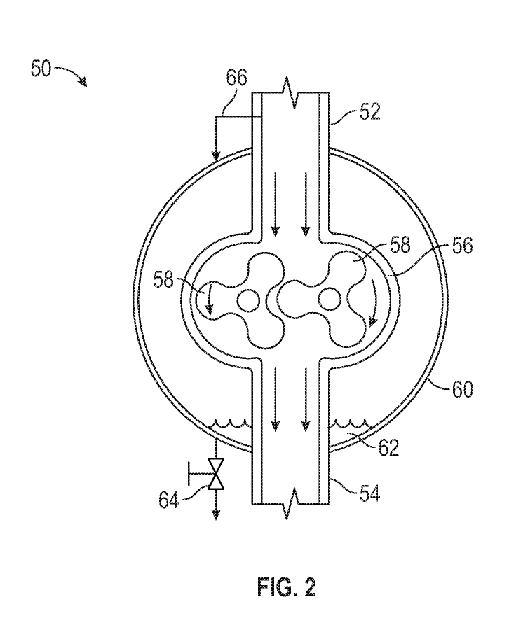

Referring to FIGS. 1 and 2, an embodiment of a compressor 50 of the evaporation system 10 of FIG. 1 is shown in FIG. 2. In the embodiment of FIG. 2, compressor 50 comprises a rotary lobe compressor including a fluid inlet 52, a fluid outlet 54, an inner housing 56, a pair of lobed impellers 58 positioned in inner housing 56, and an outer or pressure housing 60. Although rotary lobe compressors (often called Roots blowers) may be an attractive Option, an issue of at least some rotary lobe compressors is that they may operate only at low pressures (e.g., less than about 25 psig to about 35 psig). To achieve high heat transfer coefficients in the latent heat exchanger, the evaporation system 10 may operate at a relatively high pressure. This incongruence may be overcome by placing the rotary lobe compressor in a pressure vessel. In this embodiment, high pressure steam 62 is injected into pressure housing 60 via a pressure housing valve 64 to apply a predetermined pressure to an outer surface of inner housing 56. Particularly, during start-up of compressor 50, high-pressure steam is bled into pressure housing 60, thermalizing compressor 50 and allowing both the rotors 58 and inner housing 56 to reach the same high temperature. In this manner, heating compressor 50 via steam injected into pressure housing 60 while rotors 58 are stationary within pressure housing 60 may allow thermal expansion to occur in compressor 50 without damaging compressor 50. For instance, if heating were to occur while rotors 58 are rotating within inner housing 56, the potential may exist for rotors 58 to contact inner housing 56 or each other, potentially damaging compressor 50. This isothermalization procedure may ensure that tight gaps may be maintained without risk of a touching event during operation, and thereby may ensure high efficiency. While operating, to maintain a constant temperature and pressure in pressure housing 60, steam may be bled into pressure housing 60 from fluid inlet 52 via a bleed line 66 extending therebetween, or from fluid outlet 54. Steam that condenses in the pressure housing 60 may be drained via valve 64.

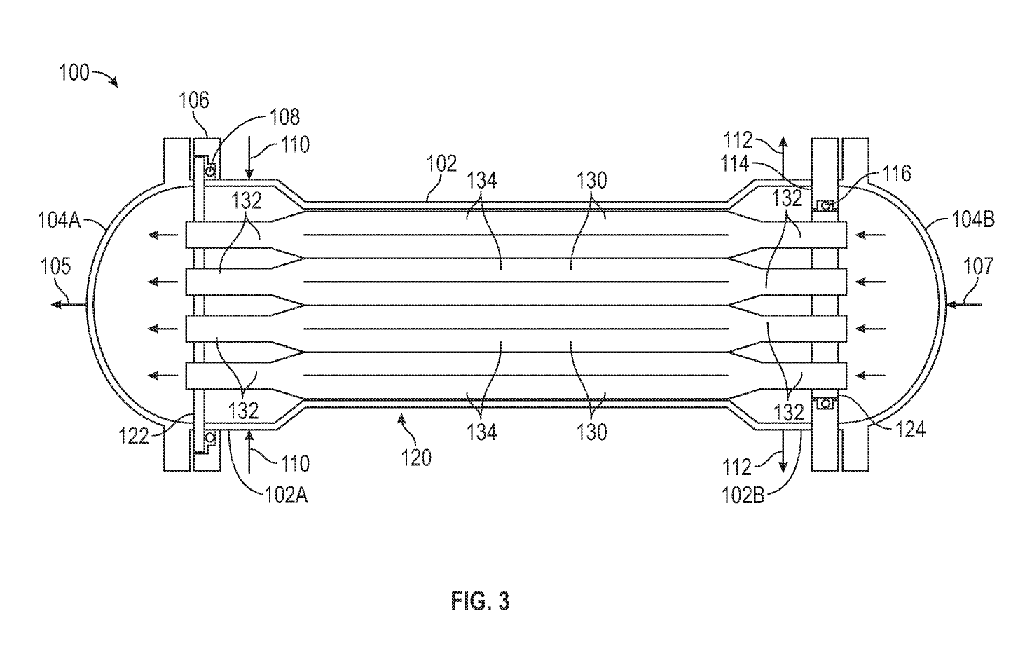

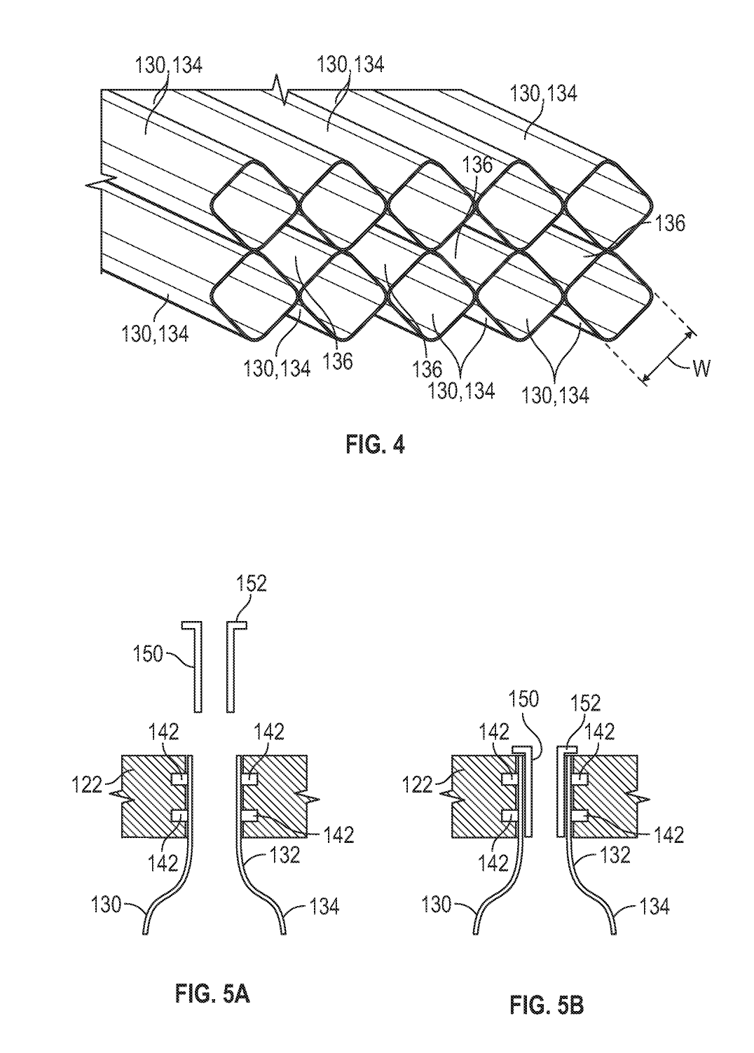

Referring to FIGS. 1, 3, and 4, an embodiment of a sensible heat exchanger 100 of evaporation system 10 of FIG. 1 is shown in FIGS. 3 and 4. In the embodiment of FIGS. 3 and 4, sensible heat exchanger 100 generally includes a cylindrical shell 102 and a tube assembly 120 disposed in shell 102. Shell 102 has a first end 102A and a second end 102B positioned opposite first end 102A, where the diameter of shell 102 is greater at ends 102A, 102B, than the portion of shell 102 extending between ends 102A, 102B. In this embodiment, the first end 102A of shell 102 includes a radially outwards extending flanged connector or flange 106. Additionally, the second end 102B of shell 102 includes a radially inwards extending flange or tube sheet interface 114. Shell 102 additionally includes one or more shell-side fluid inlets 110 located at or proximal to first end 102A and one or more shell side fluid outlets 112 located at proximal to second end 102B. Shell 102 further includes a first shell cap 104A that couples with first end 102A and a second shell cap 104B that couples with second end 102B. In this embodiment, second shell cap 104B includes a tube-side fluid inlet 107 while first shell cap 104A includes a tube side fluid outlet 105.

Tube assembly 120 of sensible heat exchanger 100 includes a first tube sheet 122, a second tube sheet 124 positioned opposite first tube sheet 122, and a plurality of heat exchanger tubes 130 extending between the first tube sheet 122 and second tube sheet 124. In this embodiment, each tube 130 has a pair of cylindrical end sections 132 extending from each end of tube 130, and a central section 134 having a square or rectangular cross-section, extending between the end sections 132, as shown in FIG. 4. To resist high pressure, shell 102 may have a circular cross section; however, in other embodiments for low-pressure operation, shell 102 may have a square or rectangular cross section. Tubes 130 are arranged such that the outer surface of each central section 134 contacts the central section 134 of at least one other tube 130, forming a plurality of square channels 136 (shown in FIG. 4) located between the central sections 134 of tubes 130.

A tube-side fluid flowpath of sensible heat exchanger 100 extends between tube side fluid inlet 107, second shell cap 104B, tubes 130, first shell cap 104A, and tube side fluid outlet 105. A shell-side fluid flowpath of sensible heat exchanger 100 extends between shell-side fluid inlets 110, square channels 136, and shell-side fluid outlet 112. In this arrangement, a first fluid may flow inside tubes 130 and a second fluid may flow outside tube 130 on the shell side. Given that the central section 134 of each tube 130 has a square cross-sectional area in this embodiment, the cross-sectional areas inside central sections 134 and in square channels 136 may be substantially the same. Tubes 130 of tube assembly 120 may be constructed from any suitable material such as copper, brass, stainless steel, carbon steel, titanium or any combination thereof. In this embodiment, tubes 130 are formed from and comprise titanium for its corrosion resistance properties.

In this embodiment, tubes 130 of tube assembly 120 are formed via a hydroforming process. Particularly, each tube 130 initially comprises a generally cylindrical member having a consistent cross-section along its axial length. In this embodiment, the initially cylindrical tube 130 is placed into a mold with a pattern that having the desired outside dimensions (in this embodiment, including a section having a square cross-section) of the finished tube 130. After the tube 130 is placed into the mold, high-pressure fluid (e.g., water) is forced into the tube 130, causing the tube 130 to expand to fill the mold and form the desired shape and dimensions. The required pressure of the fluid forced into tube 130 may depend on the wall thickness and diameter of the tube 130, and may be many hundreds of atmospheres of pressure in at least some applications, in some embodiments, the pressure of the fluid injected into tube 130 may be high enough for the stresses in the wall of tube 130 to exceed the yield strength of the material forming tube 130, so that the material deforms plastically and fills the mold in which tube 130 is positioned. In this embodiment, the mold is designed so that the central section 134 of tube 130 has a square cross-section, whereas the ends of tube 130 form end sections 132 having a smaller outer diameter than the square central section 134; however, in other embodiments, the mold may be configured to produce a tube 130 having various cross-sectional shapes and outer dimensions. For instance, in other embodiments tube 130 may include cross-sectional geometries having other shapes such as triangles, pentagons, hexagons, circles, and stars. Additionally, in other embodiments, the central section 134 may have a smaller outer diameter than the end sections 132. However, in this embodiment, outer sections 132 have a reduced outer diameter to assist in promoting even distribution of fluid between the square channels 136 of the shell side flowpath. As shown particularly in FIG. 4, unlike central sections 134, the outer surfaces of end sections 132 of each tube 130 are spaced apart, allowing fluid entering shell 102 from shell-side fluid inlets 110 to have uniform pressure in the radial direction. The major pressure drop is in the axial direction and ensures uniform flow through the square channels 136. Similarly, the pressure drop is uniform in the radial direction at the outlet. As a consequence, end sections 132 of tubes 130 and the enlarged diameter of shell 102 at ends 102A and 102B act or serve as a “distributor” so that each square channel 136 has substantially uniform flow the through, and thus, may utilize the entire heat exchange area. To promote uniform pressure in the radial direction of the small-diameter region, flow may enter (or exit) at multiple points along the circumference of shell 102.

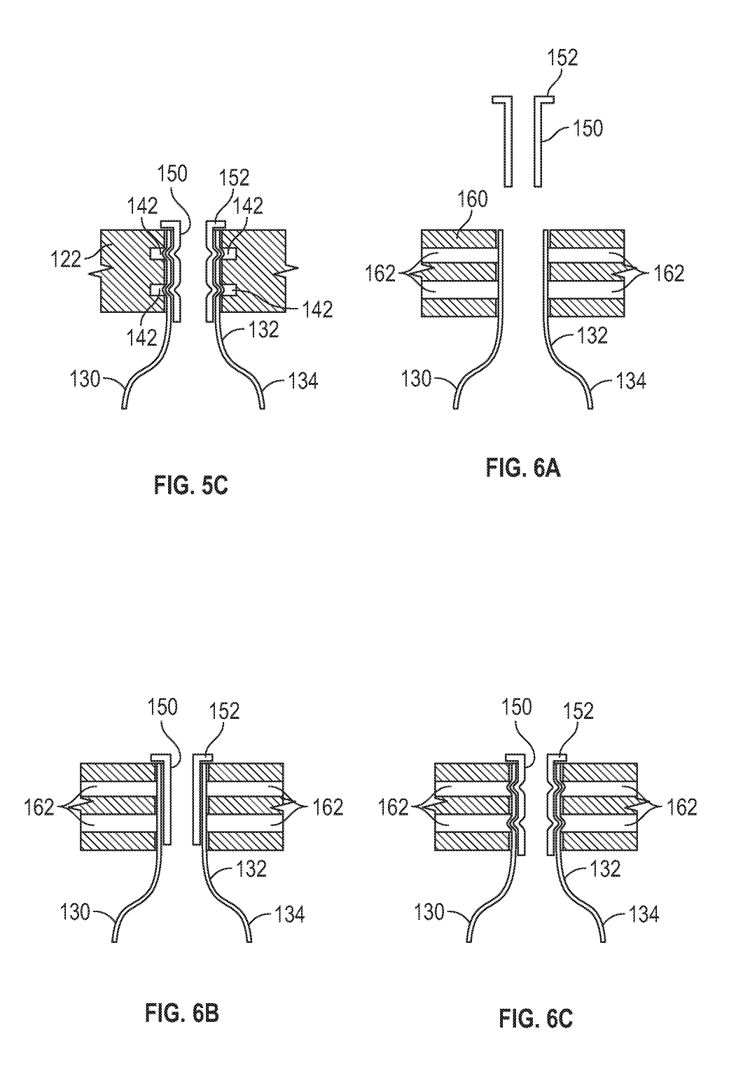

A number of methods may be available to join tubes 130 to tube sheets 122 and 124. For example, if sealing is desired, tube 130 may be welded to tube sheets 122 and 124. Other methods may include mechanical rolling and HydroSwage. Referring to FIGS. 3-6C, a first embodiment of swaging or coupling a tube 130 to the first tube sheet 122 is shown in FIGS. 5A-5C whereas a second embodiment of swaging or coupling a tube 130 to another embodiment of a tube sheet 160 is shown in FIGS. 6A-6C. Particularly, the embodiment of FIGS. 5A-5C illustrate thick tube sheet 122 whereas the embodiment of FIGS. 6A-6C illustrate a thin tube sheet 160. In the embodiment of FIGS. 5A-5C, one or more grooves 142 are machined into an inner surface of first tube sheet 122.

In order to enhance heat transfer between the tube-side and shell-side fluid flows, the wall thickness of tube 130 is minimized, increasing the difficulty of swaging or directly coupling tube 130 with either thick tube sheet 122 or thin tube sheet 160. Thus, in each of the embodiments of FIGS. 5A-5C and 6A-6C, a cylindrical thick-walled insert 1.50 having an outer flange 152 is inserted into the tube 130 to increase the thickness of the portion of tube 130 inserted into either thick tube sheet 122 or thin tube sheet 162. In this manner, when tube 130 is swaged to either the thick tube sheet 122 or thin tube sheet 160 (via applying hydraulic pressure to the interior of tube 130), the thick-walled 150 insert secures the thin-walled tube 130 so the connection formed therebetween is mechanically strong and does not leak. In the embodiment of FIGS. 6A-6C, the procedure for swaging tube 130 to thin tube sheet 160 is similar to the procedure for swaging tube 130 to thick tube sheet 122. However, in the embodiment of FIGS. 6A-6C, holes 162 may be created in an inner surface of thin tube sheet 160 by stamping or drilling the thin tube sheet 160. When stacking two or more thin tube sheets 160, there may be an annular space between the thin tube sheets 160 that may allow the tube 130 to expand into the annular space during the swaging process.

After tubes 130 are joined to the tube sheets 122 and 124, the heat exchanger core or tube assembly 120 may be inserted into the shell 102 of sensible heat exchanger 100. In this embodiment, one tube sheet may have an outer diameter that may be smaller than the inner diameter of the shell so it may fit during assembly. Particularly, first tube sheet 122 has a larger outer diameter than second tube sheet 124, allowing tube assembly 120 to be slidingly inserted into shell 102 once first shell cap 104A has been uncoupled from shell 102. When tube assembly 120 is inserted into shell 102, an outer surface of second tube sheet 124 enters into sliding engagement with an inner surface of tube sheet interface 114. An annular seal 116 is positioned between the outer surface of second tube sheet 124 and the inner surface of tube sheet interface 114. Once tube assembly 120 is inserted into shell 102, the first tube sheet 122 may be sealed to the flange 106 of shell 102 by coupling first shell cap 104A to flange 106, thereby pressing first tube sheet 122 into sealing engagement with annular seal 108. In this embodiment, annular seals 108 and 116 comprise O-ring seals; however, in other embodiments, seals 108 and 116 may comprise other types of seals, such as gaskets. Given that relative axial movement is permitted between second tube sheet 124 and tube sheet interface 114 of shell 102, the seal provided by annular seal 116 may accommodate changes in axial length of tube assembly 120 and/or shell 102 that may occur with temperature changes. In other embodiments, other methods of accommodating changes in axial length may include bellows.

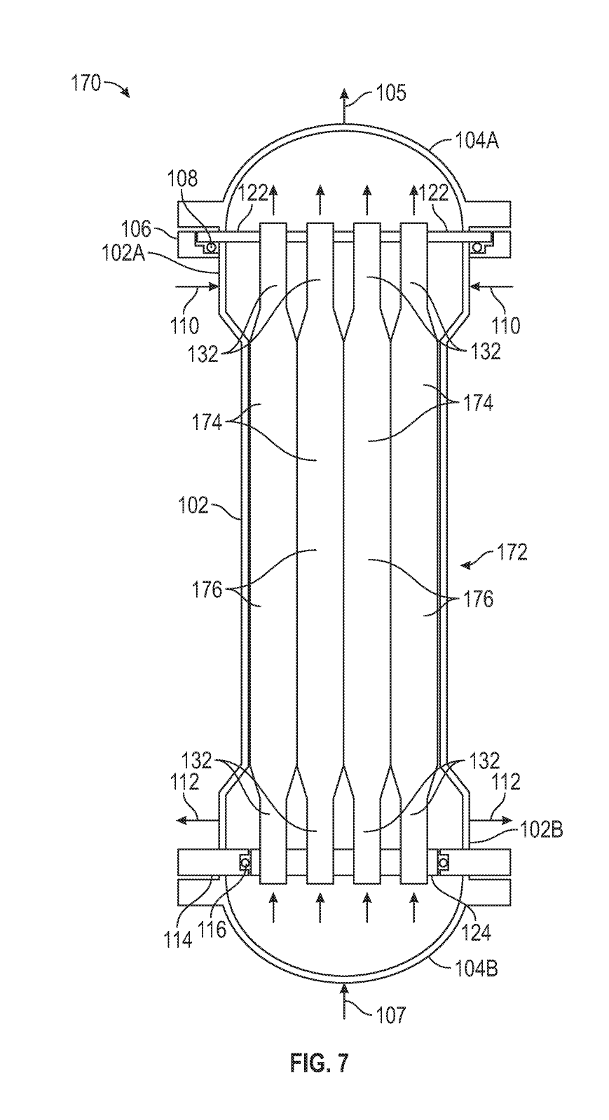

As shown particularly in FIG. 4, the central section 134 of each tube 130 contacts one or more other tubes 130 at the corners of central section 134, thereby maintaining proper spacing along the axial length of each tube 130. As mentioned previously, the cross-sectional area inside the central section 134 of each tube 130 and in square channels 136 is substantially the same. In this arrangement, in applications where the volumetric flow rate and viscosity of the tube-side and shell-side fluids are the same, the velocity and pressure drop per unit length is substantially the same on both the tube side and shell side of the sensible heat exchanger 100. This result may be obtained using other cross-sectional shapes, including tubes having central sections with triangular cross-sections, or circular cross-sections as shown in FIGS. 7-9 described below.

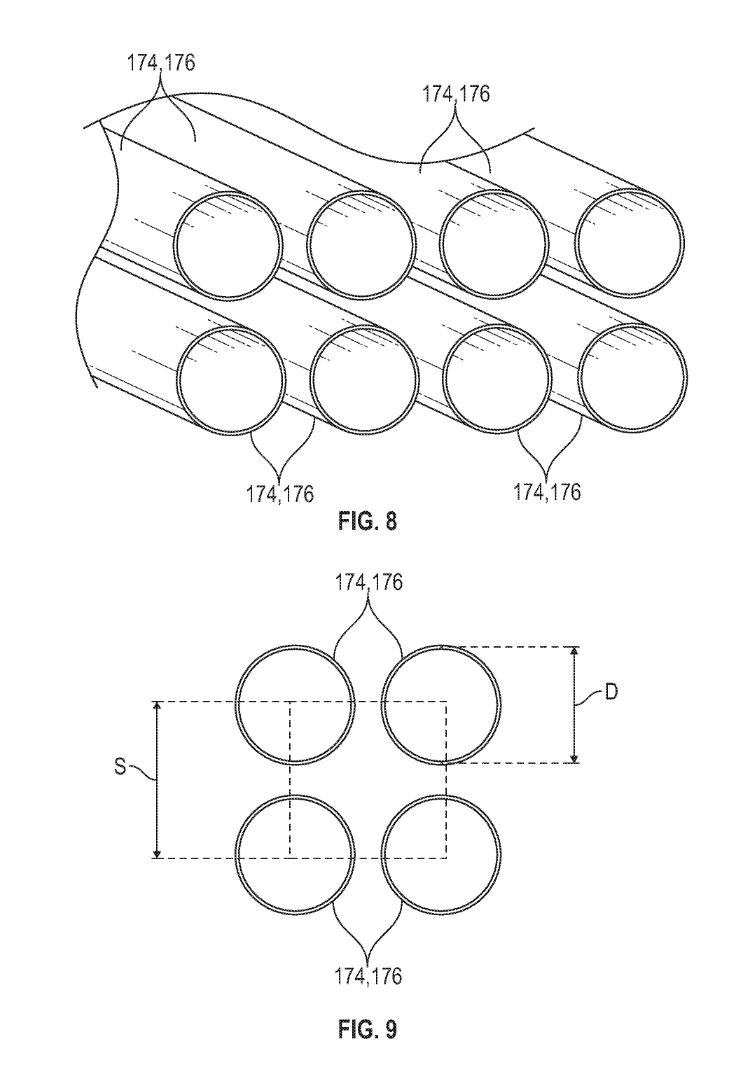

In some applications, the volumetric flow rates of the two shell-side and tube-side fluids of the sensible heat exchanger may differ, so it may be desirable to alter the tube spacing and/or geometry. For example, referring briefly to FIGS. 7-9, an embodiment of a sensible heat exchanger 170 is shown that includes a tube assembly 172 comprising a plurality of tubes 174. Tubes 174 include end sections 132 similar to tubes 130 shown in FIGS. 3 and 4. However, unlike tubes 130, each tube 174 includes a central section 176 having a circular cross-section, as shown in FIGS. 8 and 9. In the embodiment of FIGS. 7-9, the central section 176 of each tube 174 does not contact any adjacently positioned tube 174. If tubes 174 do not touch and the sensible heat exchanger 170 is mounted horizontally, tubes 174 may sag and lead to non-uniform spacing between the tubes, causing fluid to preferentially flow through the larger gaps, which may adversely affect heat transfer because fluid flows less through regions where tubes may be tightly spaced. This problem may be overcome by employing baffle plates, but they may add complexity and expense. Furthermore, baffle plates may force fluid to flow perpendicular to the tubes, which may increase a pressure drop and reduce heat transfer effectiveness because cross flow may be less efficient than true countercurrent flow. Thus, in order to eliminate need for baffle plates, in this embodiment sensible heat exchanger 170 is mounted vertically so the force of gravity may be parallel to the axis of each tube 174, and thus may prevent sagging of tubes 174.

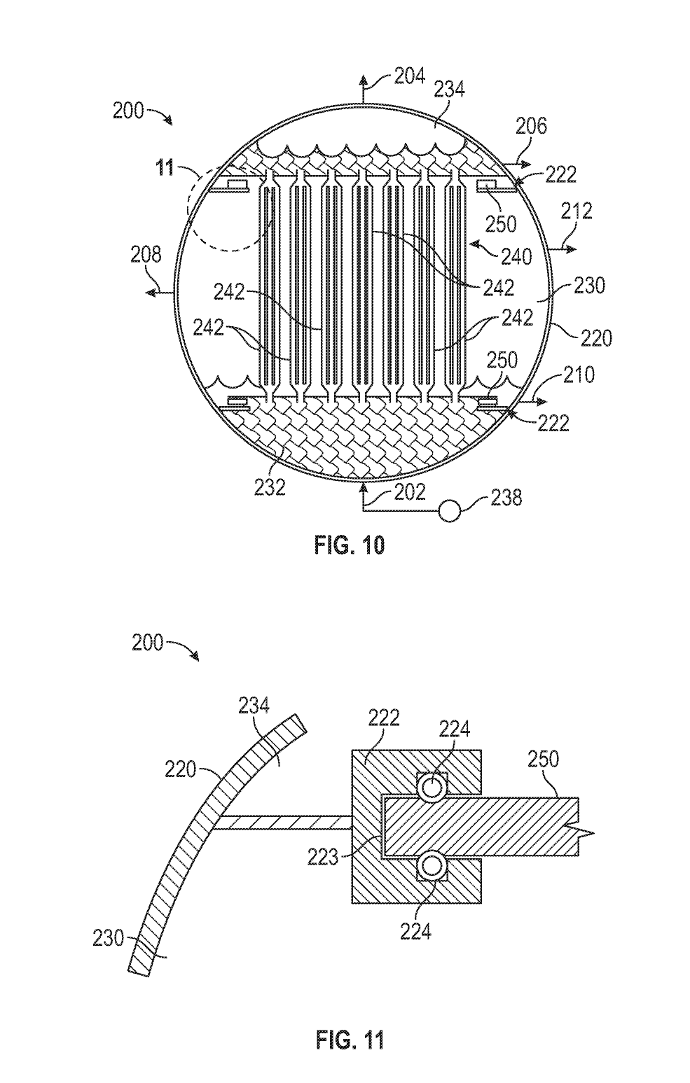

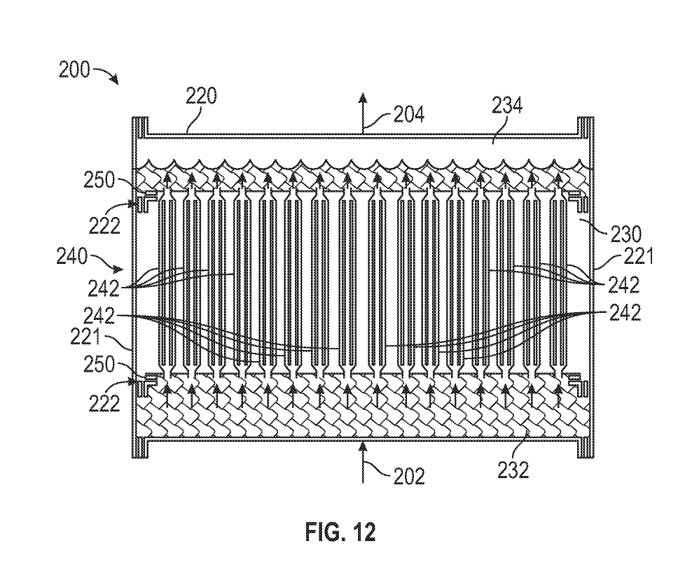

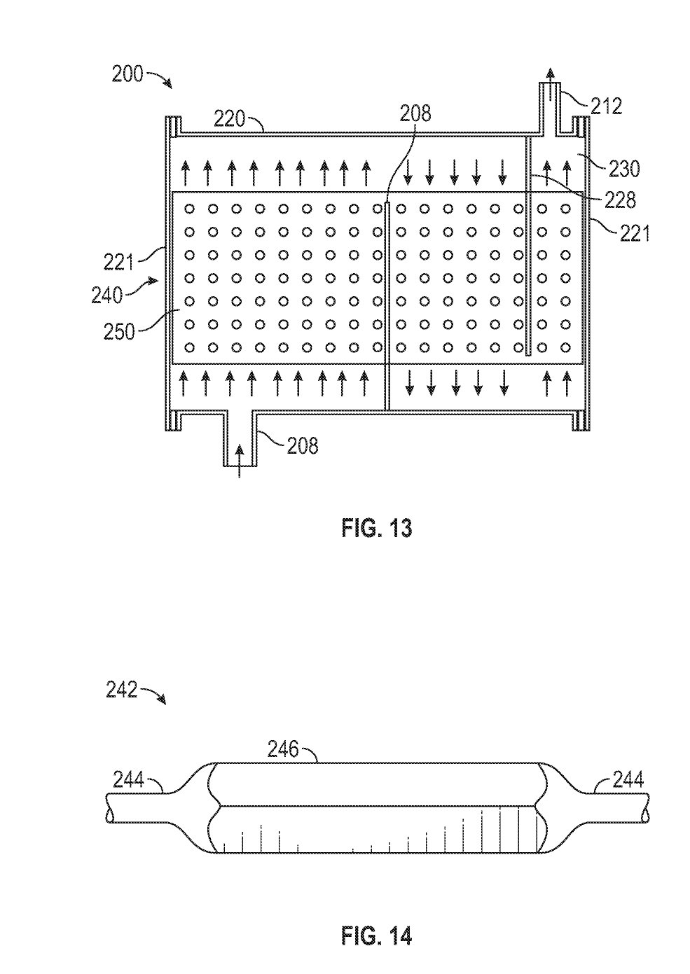

Referring to FIGS. 1 and 10-15, an embodiment of a latent heat exchanger 200 of the evaporation system 10 of FIG. 1 is shown in FIGS. 10-15. In the embodiment of FIGS. 10-15, latent heat exchanger 200 generally includes a cylindrical shell 220 and a tube assembly 240 positioned therein. Shell 220 has a pair of axial ends 221, a pair of tube sheet connectors or tracks 222 positioned near upper and lower ends of shell 220, and a plurality of axially spaced baffles 228 extending into shell 220. In addition to condenser outlet 210, the shell 220 of latent heat exchanger 200 includes a purge outlet 212 for purging fluid from shell 220. In this embodiment, the tube assembly 240 of latent heat exchanger 200 includes a plurality of heat exchanger tubes 242 extending between a pair of tube sheets 240,

As shown particularly in FIG. 11, each tube sheet 250 is received in an axially extending slot 223 formed in each tube sheet connector 222 of shell 220. In this manner, tube assembly 240 may be conveniently axially inserted into shell 220 to assemble latent heat exchanger 200. Additionally, each tube sheet connector 222 includes a pair of seals 224 that sealingly engage upper and lower surfaces of tube sheets 250. In this arrangement, seals 224 restrict fluid communication between a central shell chamber 230, a first or inlet tube chamber 232, and a second or outlet tube chamber 234. In this embodiment, seals 224 comprise hollow elastomer tubes; however, in other embodiments, seals 224 may comprise other types of seals known in the art, such as gaskets and the like. While tube assembly 240 is inserted into shell 220, seals 224 may be deflated allowing easy insertion of tube sheets 250 into tube sheet connectors 222. Once tube assembly 240 is in position within shell 220, seals 224 may be pressurized to expand the elastomer and ensure sealing engagement between seals 224 and tube sheets 250. In some embodiments, tube assembly 250 may be segmented into sections that may be joined together once they are inserted into shell 220. In this manner, should one segment of tube sheet assembly 250 require service or replacement, it may be easily separated from the other segments of tube sheet assembly 250. Tubes 242 may be joined with tube sheets 250 via a swaging process similar to that shown in FIGS. 5A-5C and/or 6A-6C,

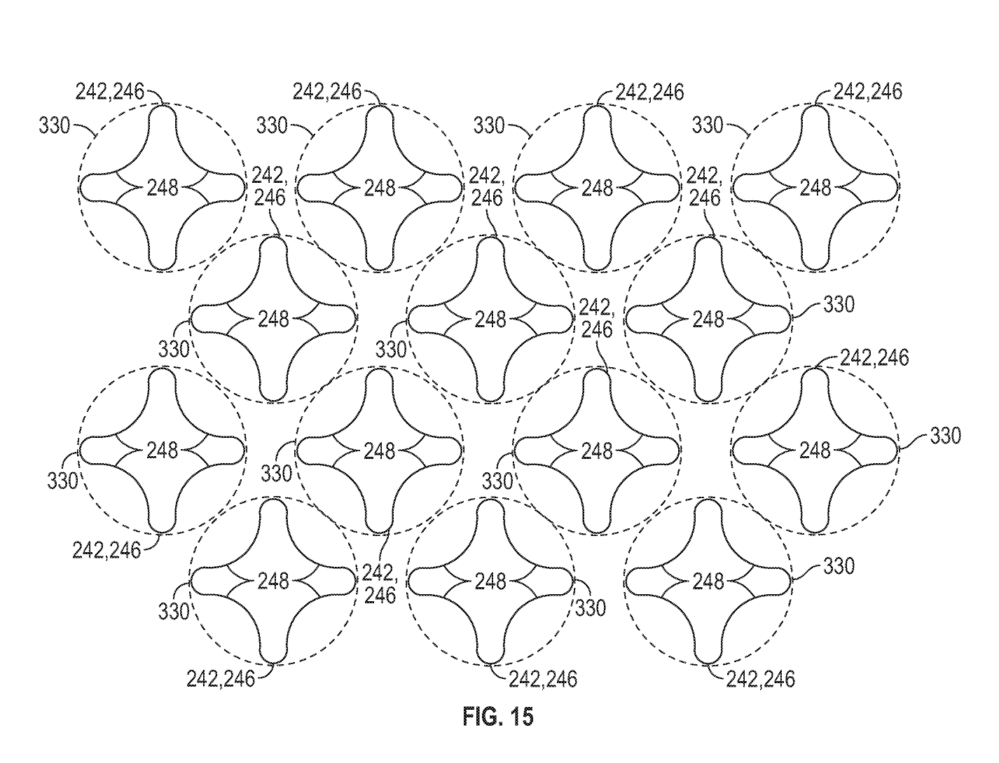

As shown particularly in FIGS. 14 and 15, each tube 242 of latent heat exchanger 200 includes a pair of cylindrical end sections 244 and a central section 246 having a star-shaped cross-section having a greater maximum width or diameter than end sections 244. The geometry of each tube 242 may be achieved using hydroforming, as discussed above. The star-shaped cross-section of central section 246 forms a plurality of concave channels 248 extending axially along the outer surface of each tube 242. Concave channels 248 are configured to direct the flow of dropwise condensation on the surface of tubes 242 along the outer surface of tubes 242 towards the condenser outlet 210 of latent heat exchanger 200. In this manner, condensation may be inhibited from sticking to the outer surface of tubes 242, which could inhibit the heat transfer provided by latent heat exchanger 200. In this embodiment, the spacing between tube sheets 250 may be relatively small (e.g., 0.5 meters), which may reduce the hydrostatic head between tube chambers 232 and 234. If the tubes were too long, the large hydrostatic head may suppress bubble formation on the liquid side (e.g., the interior) of tubes 242 and thereby may reduce the heat transfer coefficient. In this embodiment, a pump 238 is employed to pump fluid into tube inlet chamber 232 and induce upward circulation through tubes 242, which may increase convection and thereby may enhance the heat transfer coefficient. Baffles 228 of shell 220 direct the flow of steam through shell chamber 230 in a serpentine manner against the outer surfaces of tubes 242. Baffles 228 may be spaced to maintain a near-uniform velocity through shell chamber 230. As the steam flowing through shell chamber 230 condenses, the spacing of baffles 228 may be reduced to maintain near-uniform velocity. Eventually, a small portion of the steam may be purged via purge outlet 212 to remove any noncondensibles that may be present with the steam flowing through shell chamber 230.

One potential problem may be that scale may accumulate on the interior of the tubes 242 of latent heat exchanger 200 as the solute concentration increases. In particular, the following alkaline earth salts may be problematic in high-temperature evaporation: CaSO₄, BaSO₄, SrSO₄, CaCO₃, BaCO₃, and SrCO₃. In this embodiment, the impact of carbonates is minimized by acidifying the feed water (via carbonate remover 22) and removing the resulting carbon dioxide by vacuum, steam stripping, or air stripping. The impact of sulfates may be minimized by removing sulfates via ion exchange via sulfate remover 24. Should salts adhere to surfaces of tubes 242 and thereby cause fouling, they may be removed using various cleaning methods known to those who are skilled in the art, such as washing with acids, alkali, and chelating agents. Furthermore, mechanical abrasion and acoustic cavitation may be used to clean surfaces of tubes 242. Additional methods to reduce fouling may include the use of in-line devices (e.g., Colloid-A-Tron) that may promote bulk precipitation of fouling agents, or the addition of rubber balls that scour the surfaces. Creating smooth surfaces via electropolishing may also help prevent adherence of fouling agents.

As described above, the substantial removal of carbonate and sulfate anions—and their subsequent replacement with chloride anions—reduces the potential for scale formation. A synergistic benefit occurs in the case where salts are recovered from the concentrated brine. Further evaporation of water from the concentrated brine in appropriate hardware, such as a crystallizer, allows chloride salts (e.g., NaCl, MgCl₂, KCl) to be recovered without interference from the precipitation of carbonates and sulfates. Because the salts are relatively pure, they have greater economic value. Furthermore, the recovery of valuable salts from the concentrated brine allows for zero liquid discharge (ZLD) and thereby eliminates challenges associated with brine disposal. Typically, to minimize environmental damage, complex and expensive networks of pipes are required to discharge brine back into the ocean. ZLD eliminates this expense and thereby improves desalination economics.

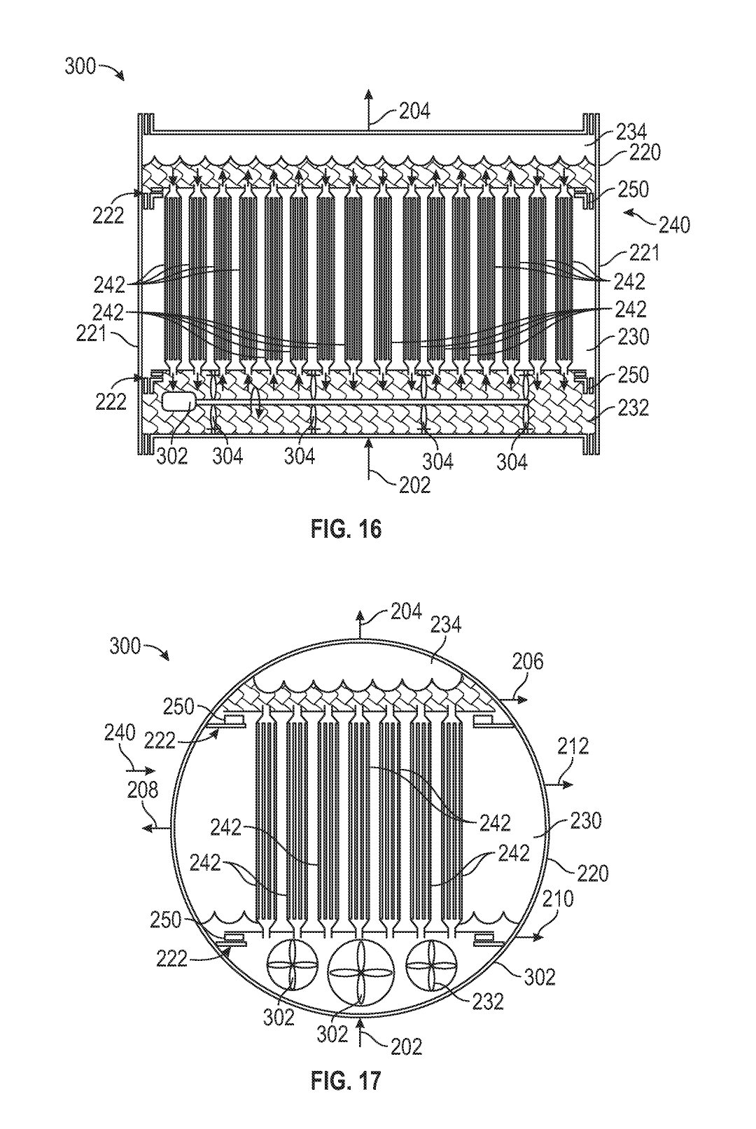

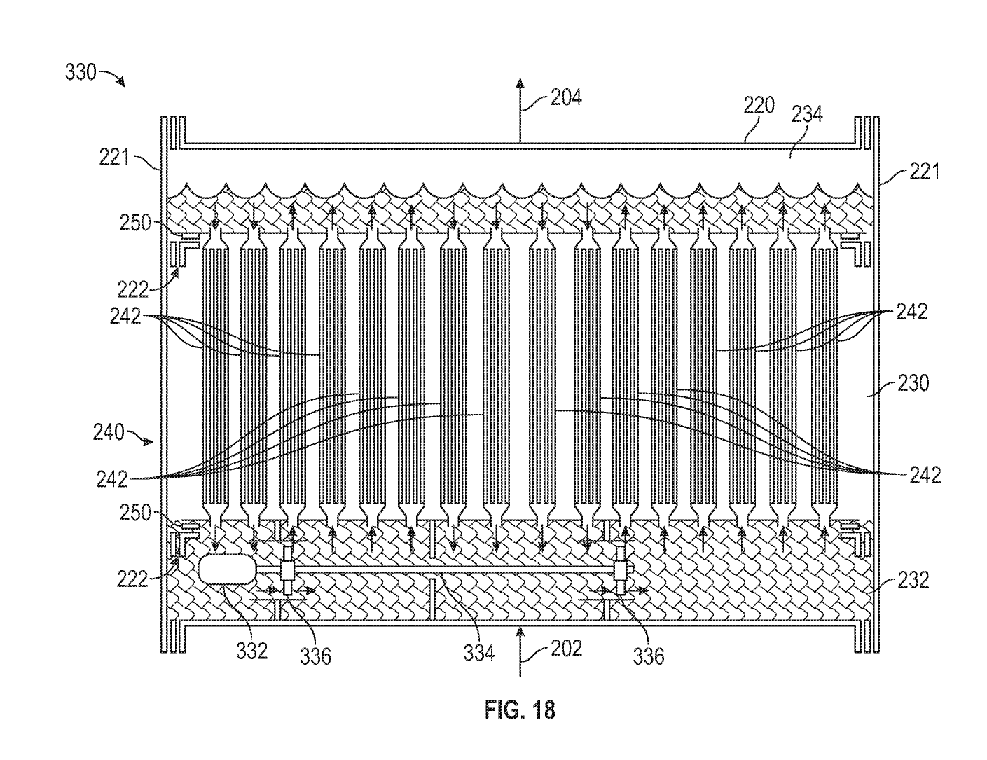

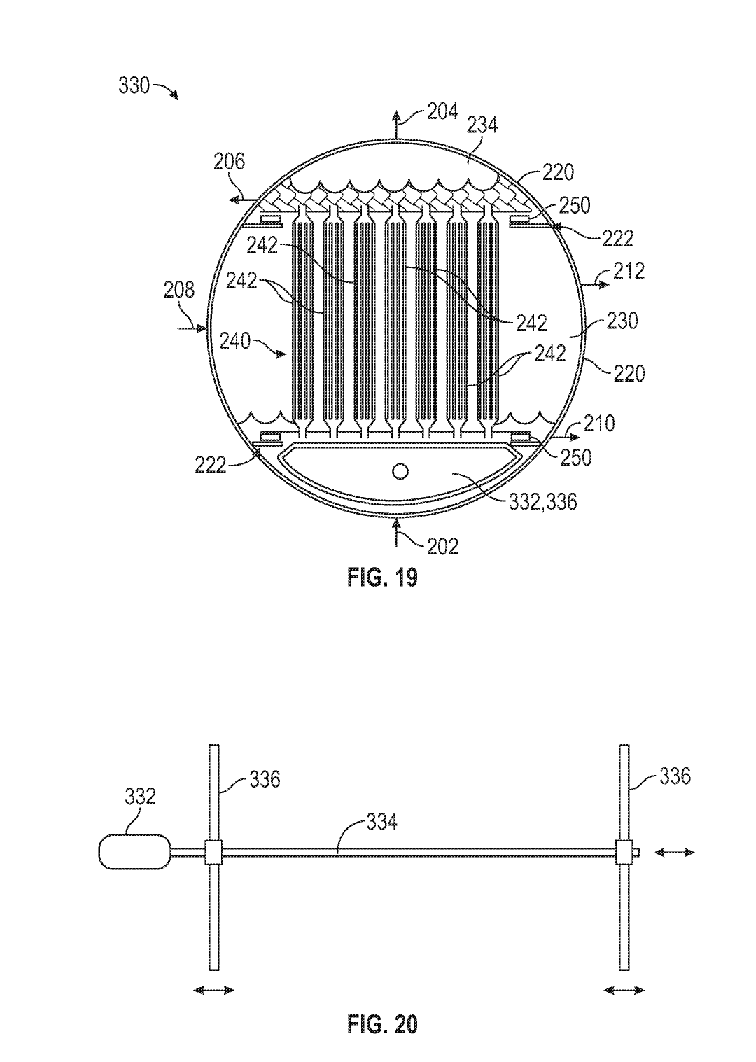

Referring to FIGS. 1, 16, and 17, another embodiment of a latent heat exchanger 300 of the evaporation system 10 of FIG. 1 is shown in FIGS. 16, 17. Latent heat exchanger 300 includes features in common with latent heat exchanger 200 shown in FIGS. 10-15, and shared features are labeled similarly. Particularly, latent heat exchanger 300 is similar to latent heat exchanger 200 except that instead of using an external pump (e.g., pump 238) to assist in circulating fluid upwards through tubes 242, latent heat exchanger 300 includes an axial pump 302 positioned in tube inlet chamber 232. Axial pump 302 includes a plurality of axially spaced rotors or impellers 304 that drive fluid flow upwards through tubes 242 of latent heat exchanger 300. 100711 Referring to FIGS. 1 and 18-20, another embodiment of a latent heat exchanger 330 of the evaporation system 10 of FIG. 1 is shown in FIGS. 18-20. Latent heat exchanger 330 includes features in common with latent heat exchanger 200 shown in FIGS. 10-15, and shared features are labeled similarly. FIG. 18 shows an embodiment that employs a single “pulse plate” train to induce convection. Particularly, latent heat exchanger 330 is similar to latent heat exchanger 200 except that instead of using an external pump (e.g., pump 238) to assist in circulating fluid upwards through tubes 242, latent heat exchanger 330 includes a pulse pump 3323 configured to both circulate fluid upwards through tubes 242 and induce high frequency vibrations in the fluid flowing through tubes 242 to thereby clean the surfaces of tubes 242. In the embodiment of FIGS. 18-20, pulse pump 332 comprises a rod 334 and a plurality of axially spaced pulse plate 336 mounted thereto which oscillate or reciprocate axially through tube inlet chamber 232 of latent heat exchanger 330. As the pulse plates 336 oscillate, they induce fluid oscillations in the tubes 242, enhancing heat transfer. The oscillations may be slow with large amplitudes that induce large bulk flow in the tubes 242. The oscillations may also be rapid with short amplitudes, thus generating acoustic waves in the fluid flowing through tubes 242, which may be known to enhance heat transfer. In this embodiment, rapid short oscillations are superimposed on large oscillations to thereby combine the benefits of bulk flow and acoustic waves in a single device.

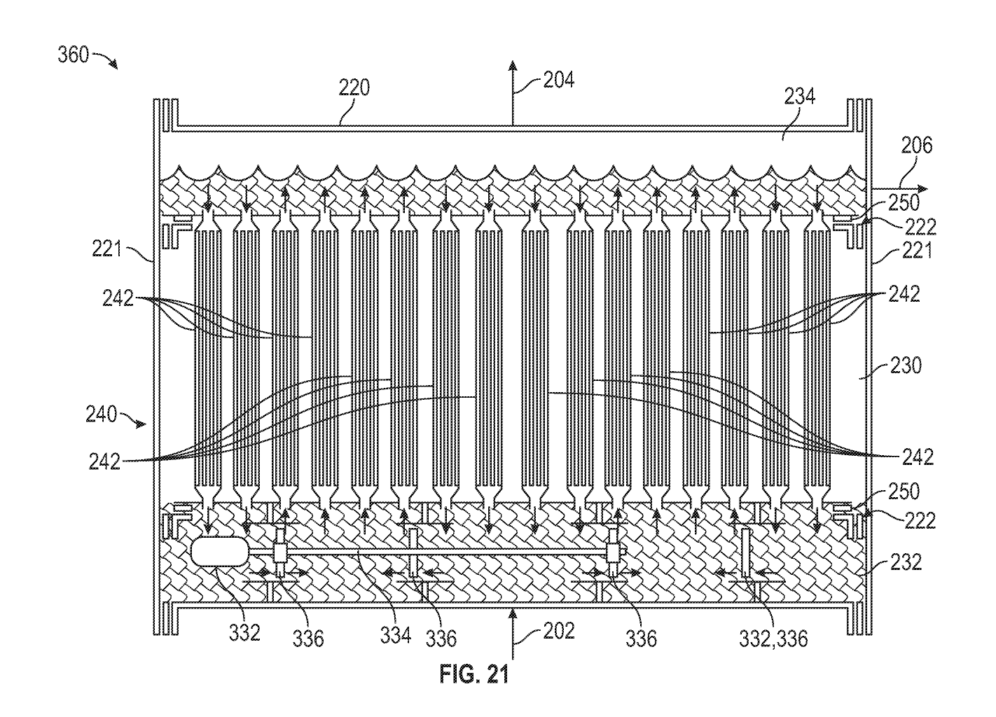

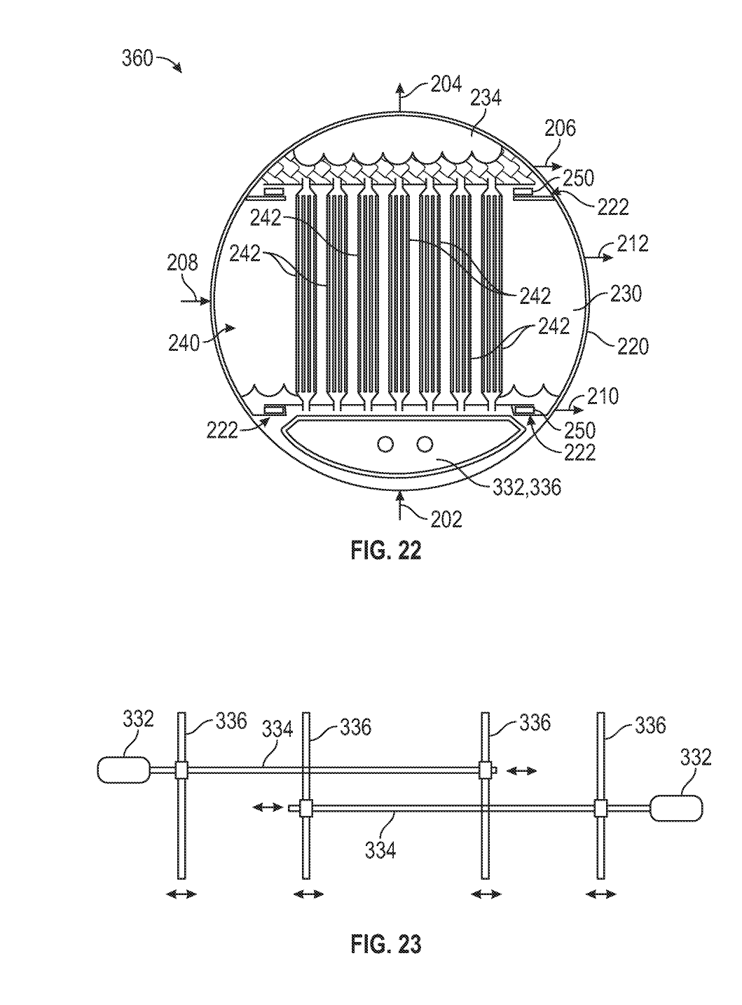

Referring to FIGS. 1 and 21-23, another embodiment of a latent heat exchanger 360 of the evaporation system 10 of FIG. 1 is shown in FIGS. 21-23. Latent heat exchanger 360 includes features in common with latent heat exchanger 200 shown in FIGS. 10-15, and shared features are labeled similarly. Particularly, latent heat exchanger 360 is similar to latent heat exchanger 330 shown in FIGS. 18-20 except that latent heat exchanger 360 includes a pair of pulse pumps 332 positioned in tube inlet chamber 232 to further enhance heat transfer in heat exchanger 360.

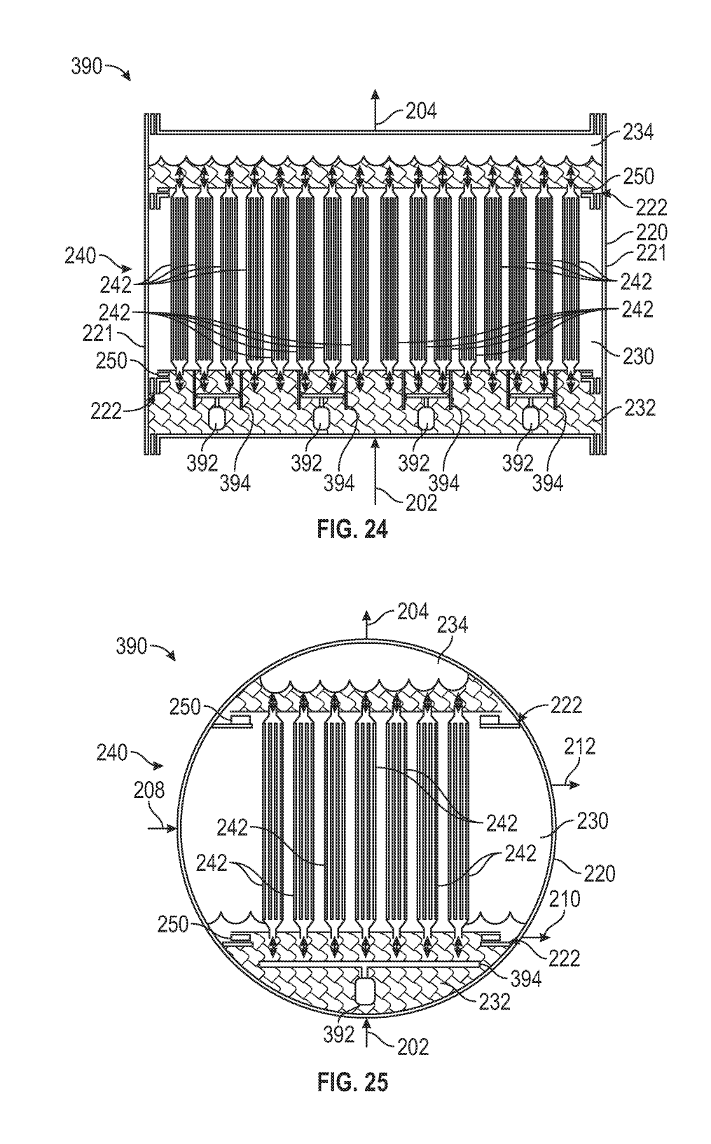

Referring to FIGS. 1, 24, and 25, another embodiment of a latent heat exchanger 390 of the evaporation system 10 of FIG. 1 is shown in FIGS. 24 and 25. Latent heat exchanger 390 includes features in common with latent heat exchanger 200 shown in FIGS. 10-15, and shared features are labeled similarly. Particularly, latent heat exchanger 390 is similar to latent heat exchanger 360 of FIGS. 21-23 except that latent heat exchanger 390 includes a plurality of vertically oriented pulse pumps 392 positioned in tube inlet chamber 232. Each pulse pump 392 includes an oscillating pulse plate 394 configured to reciprocate or oscillate towards and away from tubes 242. Each pulse pump 392 may service a section of the latent heat exchanger 390. As each pulse plate 394 moves in the upward direction towards tubes 242, liquid may be drawn from the adjacent region of tube inlet chamber 232 to fill the void behind the pulse plate 394. Similarly, as the pulse plate 394 moves in the downward direction away from tubes 242, liquid may flow to the adjacent region of tube inlet chamber 232 to accommodate the reduced volume behind the pulse plate 394. To induce the greatest flow through the tubes, each pulse pump 392 may move in synchrony. Furthermore, high-frequency oscillations may be imposed onto the slow oscillations, which further enhances heat transfer.

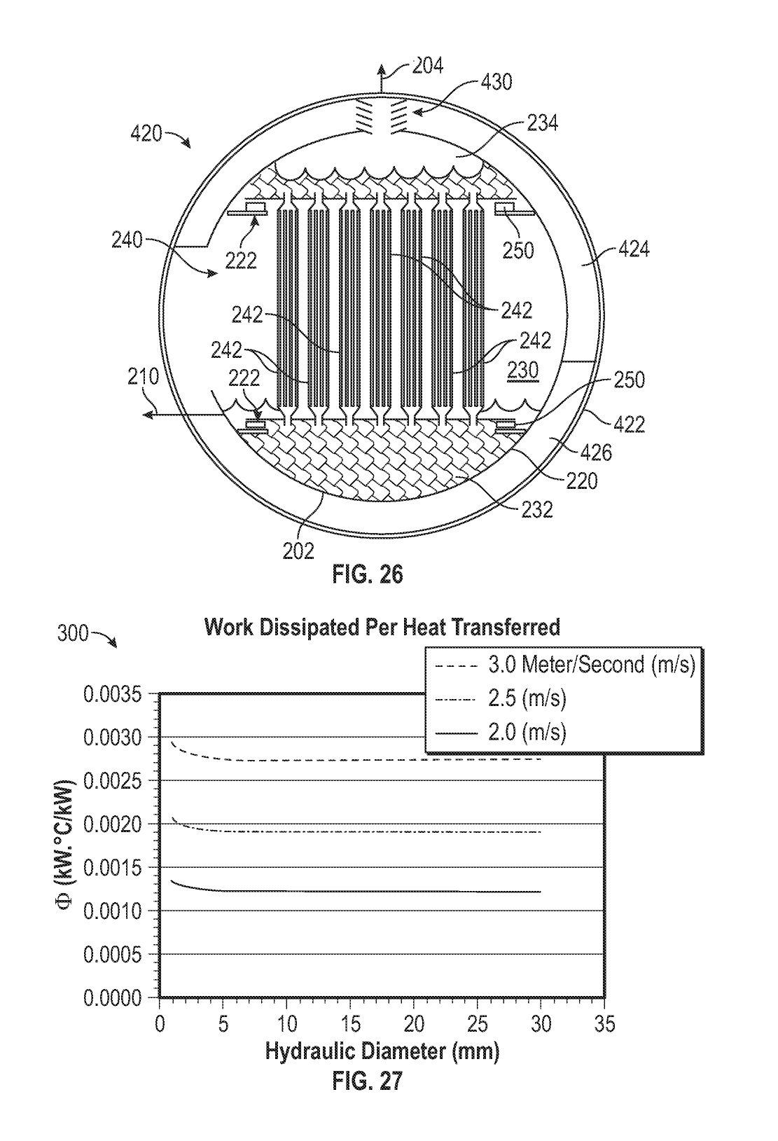

Referring to FIGS. 1 and 26, another embodiment of a latent heat exchanger 420 of the evaporation system 10 of FIG. 1 is shown in FIG. 26. Latent heat exchanger 420 includes features in common with latent heat exchanger 200 shown in FIGS. 10-15, and shared features are labeled similarly. Particularly, in the embodiment of FIG. 26, latent heat exchanger 420 includes an outer ducted shell 422 in which shell 220 is positioned. In this embodiment, the latent heat exchanger 420 is constructed from titanium (e.g., Grades 7, 11, and 12 titanium), an expensive material that resists saltwater corrosion at high temperatures up to 260° C. Because titanium allows fur high-temperature operation, the desalination system—such as that described in FIG. 1—may operate at temperatures up to 260° C. rather than the 180° C. previously described. Elevated temperatures increase pressure, which increases vapor density and thereby increases condensation heat transfer. Furthermore, titanium naturally promotes dropwise condensation, which enhances heat transfer.

In this embodiment, the outer shell 422 contacts only steam; therefore, outer shell 422 can be made from less expensive materials (e.g., carbon steel) with thick walls that withstand the pressure inside evaporation system 10. Because the pressure inside the outer shell 422 is fairly uniform, the titanium forming shell 220 and tube assembly 240 can be constructed with thin walls, which lowers costs of producing latent heat exchanger 420. The outer shell 422 includes an upper or discharge section 424 that feeds the suction of a compressor 50 of evaporation system 10. The outer shell 422 also includes a lower or inlet section 426 disposed at a relatively higher pressure than discharge section 424 and is fed by the discharge of a compressor 50 of evaporation system 10, in this embodiment, steam that disentrains from the boiling salt water in outlet tube section 234 of the latent heat exchanger 420 flows through a demister 430 to knock out or remove entrained liquid droplets that could carry into the suction of compressor 50.

Referring to FIGS. 3-6, 27, and 28, to analyze heat transfer and pressure drop in non-circular channels, the hydraulic diameter may he substituted for diameter. For the central section 134 of each tube 130 and for each square channel 136, the hydraulic diameter Dₕ may be the width of the channel: Dₕ=w. For other tube geometries, the hydraulic diameter may be readily calculated as four times the cross-sectional area divided by the wetted perimeter. Not intending to be bound by any theory, in the case of circular tubes, the spacing S (shown in FIG. 6) required to achieve the same cross-sectional flow area inside and outside the tubes is provided by Equation (1) below, where D refers to the diameter D of each circular tube (shown in FIG. 6):

$$S = \sqrt{\frac{π}{2}} D \qquad ( 1 )$$

In general, and not intending to be bound by any theory, the hydraulic diameter outside the tube Dₕₒ may be four times the cross-sectional area A divided by the wetted perimeter P, as shown below in. Equation (2):

$${D}_{ho} = \frac{4 A}{P} \qquad ( 2 )$$

When the spacing S gives the same cross-sectional area as inside the tube 130, the outside hydraulic diameter of tube 130 may be the same as the tube diameter D Not intending to be bound by any theory, Equation (3) below (v referring to the velocity of the fluid flow, ρ the density of the fluid, and μ the viscosity of the fluid) may be used to calculate the Reynold's number Re, which may be used both for pressure drop and heat transfer calculations:

$$Re = \frac{{D}_{h} v ρ}{μ} \qquad ( 3 )$$

For instance, in an example of water at approximately 121° C., the Reynold's number is approximately 4.2×10⁶ multiplied by the hydraulic diameter Dₕ and velocity v. Not intending to be bound by theory, Equation (4) below (the Dittus-Boelter Equation) may be suitable for estimating heat transfer in turbulent flow when the Reynold's number is greater than approximately 6,000, where Pr refers to the Pradtl Number (approximately 1.49 for water at 121° C.), and k refers to the thermal conductivity of the fluid (approximately 0.670 Joules/(seconds*meters squared*Kelvin):

h=0.023Rₑ^{0.8}Pᵣ^{0.333} (4)

Not intending to be bound by theory, the energy lost to friction may be calculated using the Darcy friction factor f, as shown below in Equations (5)-(7):

$$\begin{matrix}f = {8 [ {( \frac{8}{{R}_{e}} )}^{12} + \frac{1}{{( A + B )}^{3 / 2}} ]}^{1 / 12} & ( 5 ) \\ A = {[ - 2.457 ln ( {( \frac{7}{{R}_{e}} )}^{0.9} + 0.27 \frac{e}{{D}_{h}} ) ]}^{16} & ( 6 ) \\ B = {( \frac{37.530}{{R}_{e}} )}^{16} & ( 7 )\end{matrix}$$

An optimally designed heat exchanger may attempt to increase heat transfer while minimizing power dissipation from pressure drop. Not intending to be bound by theory, overall power dissipation W may be calculated using Equation (8) below while the power dissipated from friction relative to the heat transfer coefficient Φ, where V refers to volume/length of the tube and P refers to pressure:

$$\begin{matrix}W = V Δ P = \frac{Dv}{4} ( \frac{Δ P}{L} ) & ( 8 ) \\ Φ = \frac{W}{h} = \frac{Dv}{4 h} ( \frac{Δ P}{L} ) & ( 9 )\end{matrix}$$

Not intending to be bound by theory, the initial volume of metal per unit length of a cylindrical tube Vᵢₙₜ may be calculated using Equation (10) below, where d refers to initial outer diameter, tᵢ refers to initial wall thickness. In an example where the initial outer diameter is 2.0 millimeters (mm) and the initial wall thickness is 0.3 mm, the initial volume Vᵢₙₜ is approximately 1.602 mm squared.

$${V}_{int} = \frac{π}{4} {d}^{2} - \frac{π}{4} {( d - 2 {t}_{i} )}^{2} \qquad ( 10 )$$

Using a hydroforming process, the center portion of the cylindrical tube may be converted to a square tube width w and wall thickness 0.13 mm (0.005 inches). For instance, not intending to be bound by theory, given that the hydroforming process does not change the volume of metal per unit length, the width w or hydraulic diameter of the square tube can be calculated using Equation (11) below (t_{f} referring to the final wall thickness):

$$w = \frac{{V}_{int} + 4 {t}_{f}^{2}}{4 {t}_{f}} \qquad ( 11 )$$

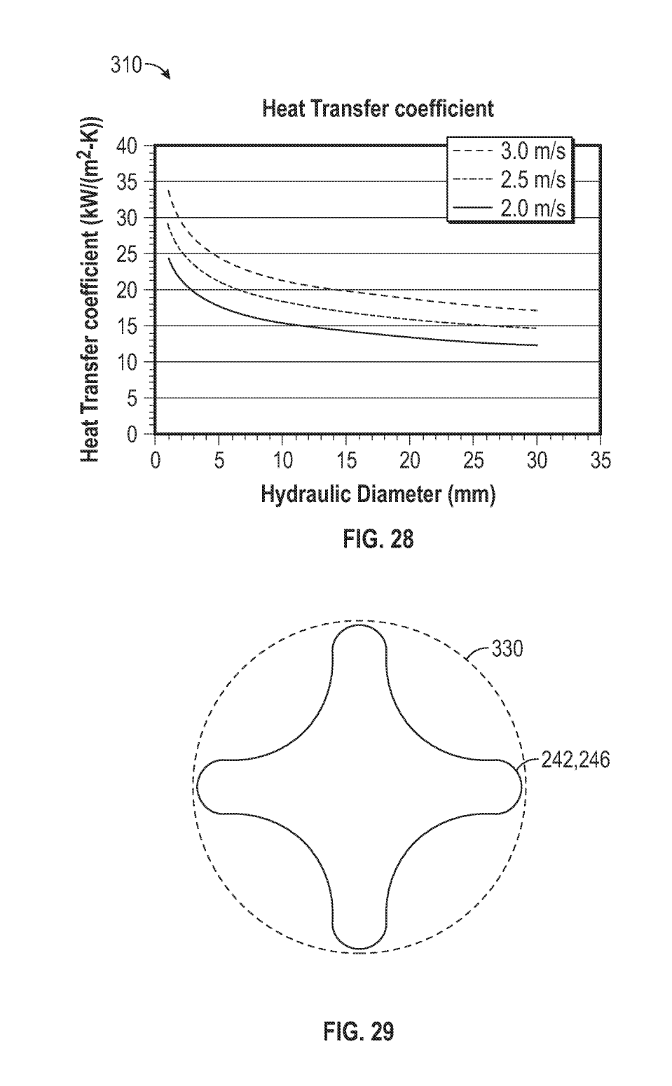

In a first example assuming velocity v=3.0 meters/second (m/s), the hydraulic diameter may be 3.21 mm so the heat transfer coefficient hₜ may be 27 kW/(m²·K), as shown in graph 310 of FIG. 28. Not intending to be bound by theory, the overall heat transfer coefficient U may he calculated from Equation (12) below as approximately 12.4 Kilowatts/(meters squared*Kelvin) (kW/(m²·K), where k refers to the thermal conductivity of the fluid (approximately 0.02 Kilowatts/(meters*Kelvin) (kW/(m·K) for water):

$$\frac{1}{U} = \frac{1}{{h}_{t}} + \frac{{t}_{f}}{k} + \frac{1}{{h}_{0}} \qquad ( 12 )$$

Graph 300 of FIG. 27 shows the work dissipation Φ is approximately 0.0028 in this example, which may be based on the difference between the wall temperature T_{wall} and the bulk temperature T_{bulk}. The metal resistance may be small relative to the films, and thus, assuming the wall temperature may he half the total approach temperature, the work dissipation Ø 0 may be calculated, without being bound by theory, using Equation (13) below:

$$φ = \frac{Φ}{\vert {T}_{wall} - {T}_{bulk} \vert} \qquad ( 13 )$$

Table 1 shows the work dissipation in a single side as a function of total approach temperature:

TABLE 1
Single-side work dissipation relative to heat transfer (v = 3.0 m/s)

| Total approach temperature (K) | ΔT_{wall} (K) | $φ ( \frac{{kW}_{work}}{{kW}_{heat}} )$ |
|---|---|---|
| 3 | 1.5 | 0.00187 |
| 6 | 3.0 | 0.000933 |
| 9 | 4.5 | 0.000622 |

In a second example assuming velocity v=2.5 m/s—the hydraulic diameter is 3.21 mm, and thus, the heat transfer coefficient is approximately 23 kW/(m²·K) as shown in graph 310 of FIG. 28. Using Equation (12) above, the overall heat transfer coefficient U may be calculated in this example as approximately 10.7 kW/(m²·K). Graph 300 of FIG. 27 shows the work dissipation Φ is approximately 0.0019 (kW·K/kW), which may be based on the difference between the wall temperature and the bulk temperature. Using Equation (13) above, the work dissipation Ø for this example (v=2.5 m/s) a single side as a function of total approach temperature, may be calculated, as shown in Table 2 below:

TABLE 2
Single-side work dissipation relative to heat transfer (v = 2.5 m/s)

| Total approach temperature (K) | ΔT_{wall} (K) | $φ ( \frac{{kW}_{work}}{{kW}_{heat}} )$ |
|---|---|---|
| 3 | 1.5 | 0.00127 |
| 6 | 3.0 | 0.000633 |
| 9 | 4.5 | 0.000422 |

In a third example assuming velocity v=2.0 m/s—the hydraulic diameter is 3.21 mm, and thus, the heat transfer coefficient is approximately 19 kW/(m²·K), as shown in graph 310 of FIG. 28. Using Equation (12) above, the overall heat transfer coefficient U may be calculated in this example as approximately 8.95 kW/(m²·K) Graph 300 of FIG. 27 shows the work dissipation Φ is approximately 0.0013 (kW·K/kW), which may be based on the difference between the wall temperature and the bulk temperature. Using Equation (13) above, the work dissipation Ø for this example (v=2.0 m/s) a single side as a function of total approach temperature, may be calculated, as shown in Table 3 below:

TABLE 3
Single-side work dissipation relative to heat transfer (v = 2.0 m/s)

| Total approach temperature (K) | ΔT_{wall} (K) | $φ ( \frac{{kW}_{work}}{{kW}_{heat}} )$ |
|---|---|---|
| 3 | 1.5 | 0.000867 |
| 6 | 3.0 | 0.000433 |
| 9 | 4.5 | 0.000289 |

The film heat transfer resistance of titanium may be 22% greater than that of tube including a Ni-P-PTFE coating (R_{film} of approximately 5.74·10⁻⁶ (m²·° C./W) for Ni-P-PTFE, versus an R_{film} of approximately 7.04·10⁻⁶ (m²·° C./W) for Titanium); however Titanium may be corrosion resistant and may be substantially less expensive than the Ni-P-PTFE coating, so the slight increase in film resistance may be acceptable given the heat transfer increasing properties of tubes 130 and 242 described above. Because the wall of each tube is thin, material costs may be low. However, in some embodiments, because a thin wall may not resist high pressures, applications may be limited to those with small pressure differences between the condensing steam and boiling water. This condition may be satisfied with vapor-compression systems that operate with low temperature differences (e.g., 0.2° C.), such as the embodiment of evaporation system 10 shown in FIG. 1.

Estimated benefit from using vertical grooves rather than dimpled sheets is shown in Table 4 below:

TABLE 4

| | | Coating | | |
|---|---|---|---|---|
| | Pressure | thickness | | Overall U |
| Surface | (kPa) | (μm) | Material | (kW/(m² · ° C.) |
| Dimpled sheet | 722 | 0.635 | copper | 159 |
| Vertical groove | 722 | 0.635 | copper | 191 |

It has been shown that elevated pressure improves heat transfer (e.g., for vertical grooves, the exponent with respect to pressure is 1.977). As an example, at 180° C.; and 1,002 kilopascals, the estimated overall heat transfer coefficient U is approximately 244 kW/m²·° C.

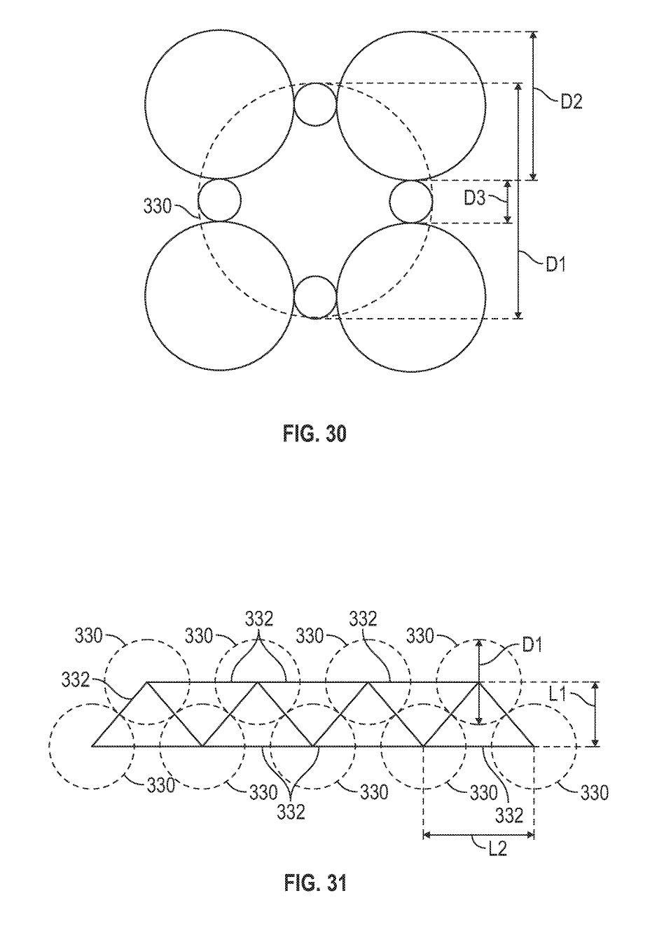

Referring to FIGS. 14, 15, 29, and 30, FIG. 29 shows the analysis of a star-shaped tube (e.g., a tube similar to tube 242 in configuration). The star-shaped tube may have vertical grooves (e.g., concave channels 248) that may increase heat transfer, as described previously. A reference circle 330 may have the same diameter as the largest diameter of the star-shaped tube. Not intending to be bound by theory, the area ratio R is the area of the star-shaped tube to the reference circle may be calculated using Equation (14) below, where diameters D₁, D₂, and D₃ are shown in FIG. 30:

$$R = \frac{2 {D}_{3} + {D}_{2}}{{D}_{1}} \qquad ( 14 )$$

FIG. 15 shows star-shaped tubes 242 and reference circles 330 arranged with the same center-to-center spacing. Note that the reference circles 330 touch each other so that there may be no room for steam to flow on the outside of the tube. In contrast, the star-shaped tubes 242 may have a significant amount of open area which may allow for unobstructed flow of steam across the outside surface. Although the star shape may have slightly less area per tube compared to a reference circle 330, they may be packed much more densely because gas may readily flow through the outside passages. FIG. 31 shows reference circles 330 with the same center-to-center spacing as shown in FIG. 30. Two triangles 332 may define a unit cell. Two triangles 332 may encompass one full reference circle 330 and one triangle 332 may encompass one semi-circle. Not intending to be bound by theory, Equation (15) below may specify the area of the star-shaped tube 242 per unit volume where L is the length of the tube 242:

$$\frac{Star area}{Volume} = \frac{0.919 π}{{D}_{1}} \qquad ( 15 )$$

Not intending to be bound by theory, the metal volume Vₛₜₐᵣ of the star tube 242 may be determined using Equations (16) and (17) below, where tₜ is the initial thickness of the cylindrical tube from which the star shape tube 242 is formed using hydroforming, and Dₜ is the initial diameter of the cylindrical tube:

Vₛₜₐᵣ=πtₜ(Dₜ−tₜ)L (16)

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A heat exchanger, comprising:
a shell; and
a tube assembly disposed in the shell, the tube assembly comprising at least one tube;
wherein the tube has a pair of end sections having a first diameter and a central section extending between the end sections having a second diameter that is greater than the first diameter.

2. The heat exchanger of claim 1, wherein each end section of the tube has a circular cross-section and the central section of the tube has a rectangular cross-section configured to provide a countercurrent flow through the heat exchanger.

3. The heat exchanger of claim 1, wherein each end section of the tube has a circular cross-section and the central section of the tube has a star shaped cross-section,

4. The heat exchanger of claim 3, wherein the central section of the tube comprises a plurality of concave channels formed on an outer surface thereof.

5. The heat exchanger of claim 1, wherein the tube assembly comprises a plurality of the tubes, and wherein each tube of the tube assembly contacts another tube of the tube assembly.

6. The heat exchanger of claim 5, wherein a plurality of square channels are formed between the central sections of the plurality of tubes.

7. The heat exchanger of claim 1, further comprising:
a pair of tube sheet connectors extending from the shell; and
a pair of tube sheets coupled to the tube of the tube assembly and slidably insertable into the tube sheet connectors.

8. The heat exchanger of claim 1, further comprising a pump disposed in the shell and configured to pump a fluid through the tube of the tube assembly.

9. The heat exchanger of claim 8, wherein the pump comprises a pulse plate and is configured to produce short oscillations and superimposed large oscillations in the pulse plate.

10. The heat exchanger of claim I, further comprising an outer shell configured to receive the shell and the tube assembly.

11. A desalination system, comprising:
a heat source configured to produce steam; and
a first shell-and-tube heat exchanger comprising an evaporator and a condenser;
wherein the evaporator is configured to receive a feed stream of seawater mixed with the steam produced by the heat source and output a separated vapor stream and a separated liquid stream from the received feed stream;
wherein the condenser is configured to condense the vapor stream produced from the evaporator into a distilled water stream.

12. The desalination system of claim 11, further comprising a compressor configured to compress the vapor stream outputted from the evaporator.

13. The desalination system of claim 12, wherein the compressor comprises:
an inner housing;
a plurality of lobed rotors disposed in the inner housing;
an outer housing that receives the inner housing;
a fluid inlet configured to provide a fluid flow to the inner housing; and
a fluid outlet configured to discharge fluid from the inner housing.

14. The desalination system of claim 1, further comprising a second shell-and-tube heat exchanger comprising:
a shell; and
a tube assembly disposed in the shell, the tube assembly comprising at least one tube;
wherein the tube has a pair of end sections having a first diameter and a central section extending between the end sections having a second diameter that is greater than the first diameter.

15. The desalination system of claim 14, wherein the central section of the tube comprises a plurality of concave channels formed on an outer surface thereof.

16. The desalination system of claim 11, wherein the evaporator comprises the tube side of the first shell-and-tube heat exchanger and the condenser comprises the shell side of the first shell-and-tube heat exchanger.

17. A method for vapor-compression desalination comprising:
(a) flowing a feed stream into an evaporator of a first shell-and-tube heat exchanger;
(b) separating the feed stream in the evaporator of the first shell-and-tube heat exchanger into separated vapor stream and a separated liquid stream; and
(c) condensing the separated vapor stream in a condenser of the first shell-and-tube heat exchanger.

18. The method of claim 17, wherein the evaporator comprises the tube side of the first shell-and-tube heat exchanger and the condenser comprises the shell side of the first shell-and-tube heat exchanger.

19. The method of claim 17, further comprising:
(d) flowing the feed stream through a second shell-and-tube heat exchanger; and
(e) flowing the condensed fluid outputted from the condenser of the first shell-and-tube heat exchanger countercurrently through the second shell-and-tube heat exchanger.

20. The method of claim 19, further comprising;
flowing the condensed fluid through a turbine to produce shaft work;
